(19) United States
(12) Patent Application Publication
(10) Pub. No.: US 2002/0128039 A1
(43) Pub. Date: Sep. 12, 2002

(54) Method and apparatus for enabling communication and synchronization between an information processing device and a personal digital assistant using impulse radio wireless techniques

(75) Inventor: James S. Finn, Huntsville, AL (US)

Correspondence Address: William J. Tucker, Esq., 8650 Southwestern Blvd # 2825, Dallas, TX, 75206-2688, US

(73) Assignee: Time Domain Corporation

(21) Appl. No.: 09/750,822

(22) Filed: Dec. 28, 2000

(51) Int. Cl. H04B 1/38

(52) U.S. Cl. 455/556; 455/412

(57) ABSTRACT

A method and apparatus for communications between an information processing device and an external device, such as a personal digital assistance (PDA), via impulse radio wireless communications techniques and a method for controlling the same. The information processing apparatus can periodically accesses a predetermined server machine (e.g., a Web server) to acquire a desired file (e.g., an HTML file). The information processing apparatus attempts to continually perform caching of the most recent downloaded data. As a result, when the PDA, as an external device, is set into impulse radio communication mode and a user simply holds the PDA to a predetermined discoverable region of the information processing apparatus, a connection between them is established, thereby enabling the PDA to receive the most recent downloaded data.

### BACKGROUND OF THE INVENTION

1. Field of the Invention

The present invention relates to an information processing apparatus capable of executing different applications programs such as PIM (Personal Information Manager) software, a Web browser or the like and, more particularly, to an information processing apparatus that has an impulse radio communication function for exchanging data with an external device such as a PDA (Personal Digital Assistant). More specifically, this invention relates to an information processing apparatus that is capable of smoothly transferring data, such as processed results obtained from execution of an application program such as Microsoft Outlook, or an HTML (HyperText Markup Language) file acquired from a Web server in accordance with the TCP/IP (Transmission Control Protocol/Internet Protocol) protocol or the like, to the external device by using impulse radio communication techniques.

2. Background of the Invention and Related Art

With the miniaturization of technology and the desire for portability, smaller and smaller types of personal computers (PCs), such as desktop, tower, notebook computers, or the like, have been developed and commercially available in the marketplace. As a type of PC that is far smaller than a notebook PC (e.g., palm top type PC), the so-called “PDA” (Personal Digital Assistant) is now widespread in the industry. In general, a PDA is designed to have a much smaller size and a much lighter weight than a notebook PC, thereby to further improve its mobility.

A typical example of PDAs is a mobile type information processing device called a Palm Pilot from 3Com corporation. Another example of PDAs are a Compaq iPAQ Pocket or Aero 1500 as well as an “IBM ChipCard VW-200” (hereafter called “VW-200”), which is commercially available from IBM Japan, Ltd. Other examples are the IBM Workpad as well as other PDAs that run under other operating systems including, for example, Window CE from Microsoft Corporation.

A primary use of a PDA is to manage and to browse personal information or PIM (Personal Information Manager) data, such as a calendar, a schedule, an address book, a memorandum book or the like. Another use of a PDA is to browse a Web page under a mobile environment. Obviously, an advantage of a PDA is in its excellent mobility. A user of a PDA is capable of easily referencing/updating his/her own PIM information, or browsing a Web page under the mobile environment.

Such data handled by a PDA may be directly edited by a user on a PDA, or there may be another implementation wherein a PDA is automatically connected to a network on its own initiative, thereby to directly acquire an HTML file from a Web server. However, a PDA is much smaller than a notebook PC and, in proportion to its size, its display as an output device and its keyboard/tablet as an input device have to be smaller in size. In other words, its working environment for inputting/editing is not deemed rich enough. Further, any substantial PIM software requires a larger program size and, thus, it is not adapted for execution on a PDA due to a limited computing power of a CPU and/or a limited memory capacity. Further, with respect to acquisition of Web data, supporting of the TCP/IP protocol on a PDA involves certain technical difficulties, which necessarily leads to prohibitive increase of costs. In general, under a mobile environment, connection to the Internet is not always expected. While it takes at least several minutes in time to access a Web server and to transfer data, such operation time just for waiting may not be disregarded by an internal battery of a PDA that has a relatively small size and a small capacity.

Thus, it is already known to pre-edit PIM data for a PDA by using PIM software on a desktop or a notebook PC acting as a host PC, to cut a desired portion only out of the saved PIM data, and then to download it to the PDA. Also, it is already known to download an HTML (HyperText Markup Language) file from a desired Web page to a host PC connected to the Internet in advance and then, responsive to a request from a PDA, to download the saved HTML file (e.g., a text portion only of the HTML file) to the PDA.

Since various computer systems including PCs are provided with serial communication ports or the like as standard features adapted for data communications by wire, it is not technically difficult to download data by wire. However, it is not advantageous to implement downloading from a host PC to a PDA by wire or cable connection. This is because a downloadable place is constrained by a connection cable and thus takes some time to attach the cable. Further, in a case where a host PC acting as an originator of data (reservoir of download data) is shared by plurality of PDAs, it follows that a cable is frequently connected to and disconnected from each PDA and, hence, its connector portion may be subject to mechanical damages quite often (in particular, for the layman who is not accustomed to connecting/disconnecting a cable, damage to the connector would not be an uncommon occurrence but would be detrimental). Further, each PDA acting as a recipient or a destination must conform to the standardized requirements of a cable connector provided at a host PC. Moreover, each user has to carry a cable and this may degrade mobility of his/her PDA.

Recently, infrared communications have been widely used for data communications between devices. While infrared communications were originally used for remote control of household electric appliances such as TV sets or air conditioners, they are now frequently adopted for data exchange between computers. Briefly, a sending or transmitting side modulates digital signals and controls light emitting diodes to radiate infrared pulses for transmitting data on air, whereas a receiving side receives and amplifies the data for demodulating the digital signals. Such a basic principle applies to the remote controls and the computer communications as well.

Regarding the aforesaid data transfer between a host PC and a PDA, i.e., downloading of data to the PDA, it has been already attempted to use an infrared communication for this sort of data transfer. For example, a Japanese Patent Publication, which is identified as JA PUPA 8-79330, discloses data transfers between information processing devices by an infrared communication.

More particularly, the disclosed PDA having an infrared communication function establishes an infrared connection with a connecting device for connecting to a network on its own initiative, thereby to acquire a file from a server machine on the network. However, as a prerequisite requirement, the disclosed PDA must be provided with its own modem protocol (e.g., Microcom Networking Protocol or the like). Provision of such a protocol means that the requirements for hardware/software of this device are complicated, which leads to a substantial increase of costs involved. Further, since the disclosed PDA is arranged to access a server on the network on its own initiative, the PDA must keep its operating state during accessing and during the entire period of data transfers involved, which causes the battery to be consumed rapidly.

Also, in “Color Zaurus” of Sharp Corp. or “Windows CE” developed by Microsoft Corp. for PDAS, techniques have already been implemented for causing a PDA to acquire a Web page. Namely, a PDA is rendered to directly acquire Web data without any involvement of an external host computer system. However, they are designed such that a PDA is connected to a network (e.g., the Internet) for acquiring data on its own initiative and, thus, a PDA is subject to very large burdens imposed thereon in terms of access time, control of the TCP/IP protocol or the like.

Lastly, U.S. Pat. No. 6,088,730, entitled “Methods and apparatus for downloading data between an information processing device and an external device via a wireless communications technique” discloses an invention to provide an information processing apparatus that has an infrared communication function for communicating with an external device such as a PDA (Personal Digital Assistant), as well as a method of controlling the same. It also discloses an invention to provide an improved information processing apparatus that is capable of transferring data, such as processed results obtained from execution of an application program, an HTML file acquired from a web server in accordance with the TCP/IP (Transmission Control Protocol/Internet Protocol) protocol or the like, to an external device (PDA) by using an infrared communication function.

However, the methods described in the '730 patent are dramatically hindered by the communication means used. As mentioned above and in the patents incorporated herein by reference, typical wireless communication including traditional RF and infrared which are contemplated in this application are plagued by problems; including inter alia Raleigh fading, multipath propagation problems and bandwidth and range constraints as well as obstruction problems and line of sight requirements.

Thus, there is a need in the art to provide communications between an information processing device and a personal digital assistant and method for controlling the same via a wireless communications technique that is not hindered by the present limitations of infrared or traditional RF wireless systems.

### SUMMARY OF THE INVENTION

It is an object of the present invention to provide a means for communication between an information processing device and an external device such as a personal digital assistant via impulse radio wireless communications techniques and a method for controlling the same.

In order to achieve the above object, according to a preferred embodiment of the present invention, there is disclosed herein a first aspect of the present invention which includes an information processing apparatus having an impulse radio communication function that comprises: an impulse radio transceiver for transmitting/receiving an impulse radio code; a memory for storing downloaded data; input means for allowing a user to input user commands; and means, responsive to a data download command from the user, for entering and search for a destination station, such as a personal digital assistant to which data is to be downloaded.

It is another object of the present invention to periodically access a predetermined server machine (e.g., a Web server) to acquire a desired file (e.g., an HTML file). The information processing apparatus attempts to continually perform caching of the most recent downloaded data, which was downloaded via impulse radio means. As a result, when the PDA as an external device is set into impulse radio communication mode and a user simply holds the PDA to a predetermined discoverable region of the information processing apparatus, a connection between them is established, thereby enabling the PDA to receive the most recent data.

In order to achieve the above object, there is disclosed the following additional aspects of numerous preferred embodiments.

In this second aspect of the present invention, there is disclosed an information processing apparatus having an impulse radio communication function which comprises: an impulse radio transceiver for transmitting/receiving an impulse radio code; a memory for storing downloaded data; input means for allowing a user to input user commands; means, responsive to a data download command from the user, for entering and staying in a station search state to transmit an impulse radio code to search for a destination station to which data is to be downloaded; means, responsive to receipt of an impulse radio code that indicates a response of station discovery from the destination station, such as a personal digital assistant, for executing an impulse radio communication to transmit the download data; and means, responsive to termination of the impulse radio communication with the destination station, for returning to the station search state.

The information processing apparatus relating to either of the first or second aspect may include means, responsive to a direction from the user, for exiting the station search state.

According to a third aspect of this invention, an information processing apparatus having an impulse radio communication function comprises: an impulse radio transceiver for transmitting/receiving an impulse radio code; connection means for connecting to a network; file acquisition means, being operative without the involvement of the impulse radio transceiver, for acquiring a file from a predetermined server through the network; a memory for storing the acquired file as download data; input means for allowing a user to input user commands; and means, responsive to a data download command from the user, for entering and staying in a station search state to transmit an impulse radio code to search for a destination station to which data is to be downloaded.

According to a fourth aspect of this invention, an information processing apparatus having an impulse radio communication function comprises: an impulse radio transceiver for transmitting/receiving an impulse radio code; connection means for connecting to a network; file acquisition means for acquiring a file from a predetermined server through the network; a memory for storing the acquired file as download data; input means for allowing a user to input user commands; means, responsive to a data download command from the user, for entering and staying in a station search state to transmit an impulse radio code to search for a destination station, such as a personal digital assistant, to which data is to be downloaded; means, responsive to receipt of an impulse radio code that indicates a response of station discovery from the destination station, for executing an impulse radio communication to transmit the download data; and means, responsive to termination of the impulse radio communication with the destination station, for returning to the station search state.

The information processing apparatus relating to either of the third or fourth aspects may include means, responsive to a direction from the user, for exiting the station search state.

According to a fifth aspect of this invention, an information processing apparatus having an impulse radio communication function of the type which transmits by itself an exchange ID (XID) command to search for a destination station, establishes a connection with the destination station in response to receipt of an XID response from the destination station indicating station discovery, and disconnects the connection in response to transmission of a disconnection (DISC) frame by itself and receipt of an unnumbered acknowledgement (UA) frame from the destination station, comprises: means for attempting to disconnect the connection by transmitting a DISC frame; and means, responsive to disconnection of the connection, for returning to a station search state to transmit an XID command.

According to a sixth aspect of this invention, a method of controlling an information processing apparatus having an impulse radio transceiver for transmitting/receiving an impulse radio code, a memory for storing download data, and input means for allowing a user to input user commands, comprises the steps of: responsive to a data download command from the user, entering and staying in a station search state to transmit an impulse radio code to search for a destination station to which data is to be downloaded; responsive to receipt of an impulse radio code that indicates a response of station discovery from the destination station, executing an impulse radio communication to transmit the download data; and responsive to termination of the impulse radio communication with the destination station, returning to the station search state.

According to a seventh aspect of this invention, a method of controlling an information processing apparatus having an impulse radio transceiver for transmitting/receiving an impulse radio code, a memory for storing download data, and input means for allowing a user to input user commands, comprises the steps of: responsive to a data download command from the user, entering and staying in a station search state to transmit an impulse radio code to search for a destination station to which data is to be downloaded; responsive to receipt of an impulse radio code that indicates a response of station discovery from the destination station, executing an impulse radio communication to transmit the download data; responsive to termination of the impulse radio communication with the destination station, returning to the station search state; and responsive to a direction from the user, exiting the station search state.

According to an eighth aspect of this invention, a method of controlling an information processing apparatus having an impulse radio transceiver for transmitting/receiving an impulse radio code, a memory for storing download data, input means for allowing a user to input user commands, and connection means for connecting to a network, comprises the steps of: responsive to a data download command from the user, entering and staying in a station search state to transmit an impulse radio code to search for a destination station to which data is to be downloaded; responsive to receipt of an impulse radio code that indicates a response of station discovery from the destination station, executing an impulse radio communication to transmit the download data; responsive to termination of the impulse radio communication with the destination station, returning to the station search state; acquiring a file from a predetermined server through the network; and storing the acquired data as the download data.

According to a ninth aspect of this invention, a method of controlling an information processing apparatus having an impulse radio transceiver for transmitting/receiving an impulse radio code, a memory for storing download data, input means for allowing a user to input user commands, and connection means for connecting to a network, comprises the steps of: responsive to a data download command from the user, entering and staying in a station search state to transmit an impulse radio code to search for a destination station to which data is to be downloaded; responsive to receipt of an impulse radio code that indicates a response of station discovery from the destination station, executing an impulse radio communication to transmit the download data; responsive to termination of the impulse radio communication with the destination station, returning to the station search state; acquiring a file from a predetermined server through the network; storing the acquired data as the download data; and responsive to a command from the user, exiting the station search state.

According to a tenth aspect of this invention, a method of controlling an information processing apparatus having an impulse radio communication function of the type which transmits by itself an exchange ID (XID) command to search for a destination station, establishes a connection with the destination station, such as a personal digital assistant, in response to receipt of an XID response from the destination station indicating station discovery, and disconnects the connection in response to transmission of a disconnection (DISC) frame by itself and receipt of an unnumbered acknowledgement (UA) frame from the destination station, comprises the steps of: attempting to disconnect the connection by transmitting a DISC frame; and responsive to disconnection of the connection, returning to a station search state to transmit an XID command.

According to an eleventh aspect of this invention, a computer readable storage medium for storing in a tangible form a computer program executable on a computer system comprising an impulse radio transceiver for transmitting/receiving an impulse radio code, a memory for storing download data, and input means for allowing a user to input user commands, said computer program comprising: a routine, responsive to a data download command from the user, for entering and staying in a station search state to transmit an impulse radio code to search for a destination station to which data is to be downloaded; a routine, responsive to receipt of an impulse radio code that indicates a response of station discovery from the destination station, for executing an impulse radio communication to transmit the download data; and a routine, responsive to termination of the impulse radio communication with the destination station, for returning to the station search state.

According to a twelfth aspect of this invention, a computer readable storage medium for storing in a tangible form a computer program executable on a computer system comprising an impulse radio transceiver for transmitting/receiving an impulse radio code, a memory for storing download data, and input means for allowing a user to input user commands, said computer program comprising: a routine, responsive to a data download command from the user, for entering and staying in a station search state to transmit an impulse radio code to search for a destination station to which data is to be downloaded; a routine, responsive to receipt of an impulse radio code that indicates a response of station discovery from the destination station, for executing an impulse radio communication to transmit the download data; a routine, responsive to termination of the impulse radio communication with the destination station, for returning to the station search state; and a routine, responsive to a command from the user, for exiting the station search state.

According to a thirteenth aspect of this invention, a computer readable storage medium for storing in a tangible form a computer program executable on a computer system comprising an impulse radio transceiver for transmitting/receiving an impulse radio code, a memory for storing download data, input means for allowing a user to input user commands, and connection means for connecting to a network, said computer program comprising: a routine, responsive to a data download command from the user, for entering and staying in a station search state to transmit an impulse radio code to search for a destination station to which data is to be downloaded; a routine, responsive to receipt of an impulse radio code that indicates a response of station discovery from the destination station, for executing an impulse radio communication to transmit the download data; a routine, responsive to termination of the impulse radio communication with the destination station, for returning to the station search state; a routine for acquiring a file from a predetermined server through the network; and a routine for storing the acquired data as the download data.

According to a fourteenth aspect of this invention, a computer readable storage medium for storing in a tangible form a computer program executable on a computer system comprising an impulse radio transceiver for transmitting/receiving an impulse radio code, a memory for storing download data, input means for allowing a user to input user commands, and connection means for connecting to a network, said computer program comprising: a routine, responsive to a data download command from the user, for entering and staying in a station search state to transmit an impulse radio code to search for a destination station to which data is to be downloaded; a routine, responsive to receipt of an impulse radio code that indicates a response of station discovery from the destination station, for executing an impulse radio communication to transmit the download data; a routine, responsive to termination of the impulse radio communication with the destination station, for returning to the station search state; a routine for acquiring a file from a predetermined server through the network; and a routine for storing the acquired data as the download data; and a routine, responsive to a direction from the user, for exiting the station search state.

According to a fifteenth aspect of this invention, a computer readable storage medium for storing in a tangible form a computer program executable on a computer system having an impulse radio communication function of the type which transmits by itself an exchange ID (XID) command to search for a destination station, establishes a connection with the destination station in response to receipt of an XID response from the destination station indicating station discovery, and disconnects the connection in response to transmission of a disconnection (DISC) frame by itself and receipt of an unnumbered acknowledgement (UA) frame from the destination station, said computer program comprising: a routine for attempting to disconnect the connection by transmitting a DISC frame; and a routine, responsive to disconnection of the connection, for returning to a station search state to transmit an XID command.

In case of considering this invention, it should be understood that an impulse radio communication can involve a parent-child relationship between an apparatus (a parent (or primary) station) that performs a station search (i.e., transmits an impulse radio XID command) and a device (a child (or secondary) station) that is responsive to the station search (i.e., returns an impulse radio XID response), and an information processing apparatus (e.g., a PC) that acquires download data in advance functions as a parent (a master), whereas an external device (e.g., a PDA) that is to receive the download data as its destination station functions as a child (a slave).

The information processing apparatus relating to the first through fifth aspects of this invention, or the information processing apparatus implementing the methods relating to the sixth through tenth aspects of this invention is arranged to download data to a lower-level, external device (e.g., a PDA) by an impulse radio communication. After a data transmission by the impulse radio communication is terminated, the apparatus automatically returns to a station search state again. For this reason, even after data downloading to the external device has been terminated, by simply holding the external device that is set into an impulse radio communication mode to a station discoverable region (i.e., within a predetermined range of an impulse radio transmitter-range being determined by the impulse radio ranging techniques described herein and in the patents incorporated herein by reference) of the information processing apparatus, a connection between them is established, thereby enabling to smoothly develop data download operations to the external device.

Further, the information processing apparatus relating to the third and fourth aspects of this invention, or the information processing apparatus implementing the methods relating to the eighth and ninth aspects of this invention is arranged to periodically access a predetermined server machine (e.g., a Web server) to acquire a desired file (e.g., an HTML file). This file acquisition operation is carried out without the involvement of operations of an impulse radio transceiver (i.e., an impulse radio connection phase with a PDA as an external device). In other words, the information processing apparatus attempts to continually perform caching of the most recent download data for the PDA. As a result, when the PDA as an external device is set into an impulse radio communication mode and a user simply holds the PDA to a station discoverable region (i.e., within the predetermined range of an impulse radio transmitter) of the information processing apparatus, a connection between them is established, thereby enabling the PDA to receive the most recent data.

Typically, it takes at least several minutes in time to access a Web server on the Internet to transfer one or more Web pages, and to store the acquired file (e.g., an HTML file) into its own memory. No matter how a line speed on a network is improved in the near future, there would be no hope to shorten the time required for acquisition of a Web page less than 1 second, due to negative factors such as control of a protocol, a disk access of a Web server, and accessing time at a gateway. Thus, if a PDA is of the type that is connected to a network on its own initiative to directly acquire a Web page, it will be inevitably subject to consumption of its own internal battery during such data acquisition. Further, in order to perform works such as control of the TCP/IP protocol, any device must have its own intelligence (i.e., a specification of hardware/software) Where a PDA itself supports works such as control of the TCP/IP protocol, it is difficult to maintain small size/light weight/immediateness, which leads to increase of costs of the device.

However, in accordance with the third, fourth, eighth and ninth aspects of this invention, the information processing apparatus attempts to continually acquire the most recent Web page in lieu of a PDA. Namely, the information processing apparatus continually performs caching of download data for the PDA. A personal computer, which is larger in size and has a greater power capacity than a PDA, may be used as the information processing apparatus. Thus, there is no need for a PDA, as an external device to receive a Web page, to support protocol control such as accessing to a Web server on its own initiative, thereby enabling to maintain its small size/light weight/immediateness. Further, while a PDA is capable of eventually acquiring a Web page, it does not access a Web server on its own initiative and, thus, it can acquire such data in a shorter period of time without consuming its internal battery having a relatively small capacity.

A general-purpose personal computer, such as a desktop type or a notebook type, may function as the information processing apparatus of this invention. In general, such a PC may be provided with much more intelligence (e.g., a network protocol, a PIM application or the like) than a small sized PDA. By connecting an intelligent PC to a network and by causing the PC to act as a primary station of an impulse radio communication, this invention enables simplification of system configuration and to reduce the size of a PDA acting as a secondary station of the impulse radio communication. Further, since the PDA itself does not perform a communication by a modem, consumption of its own power can be substantially reduced. In accordance with this invention, there is no conflict with the essential requirements of a PDA, including small size/light weight/immediateness.

Further, an impulse radio communication between the information processing apparatus and a PDA may be made completely independent of a protocol in a network and, accordingly, even if a communication scheme in the network is changed or improved in the near future, there will be no obstacle to data downloading to the PDA. In other words, there is no need for the PDA to be aware of an event in the network at all.

To summarize the above, in accordance the information processing apparatus of this invention, it is possible to smoothly download data such as PIM data or a Web page to a PDA as its destination without imposing burdens on the PDA and in a wireless methodology that dramatically improves upon previous wireless methods of transferring by traditional means, such as traditional RF or infrared.

Further, the computer readable storage medium relating to the eleventh through fifteenth aspects of this invention define a structural or functional cooperative interrelationship between a computer program and the storage medium for implementing functions of the computer program. In other words, by mounting the storage medium onto the computer system (or installing the computer program into the computer system), it becomes possible to obtain advantages similar to those of the first through tenth aspects of this invention.

Incidentally, a Basic Rate ISDN has a data transfer rate of 64 kbps, whereas an impulse radio communication can have a data transfer rate in the range of 40 Mbps or more. It should be fully understood that in accordance with the data download operation using the impulse radio communication of this invention, such data can be acquired much faster than a PDA of the type that connect itself to an ISDN on its own initiative or even the type that use infrared.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1A illustrates a representative Gaussian Monocycle waveform in the time domain;

FIG. 1B illustrates the frequency domain amplitude of the Gaussian Monocycle of FIG. 1A;

FIG. 2A illustrates a pulse train comprising pulses as in FIG. 1A;

FIG. 2B illustrates the frequency domain amplitude of the waveform of FIG. 2A;

FIG. 3 illustrates the frequency domain amplitude of a sequence of time coded pulses;

FIG. 4 illustrates a typical received signal and interference signal;

FIG. 5A illustrates a typical geometrical configuration giving rise to multipath received signals;

FIG. 5B illustrates exemplary multipath signals in the time domain;

FIGS. 5C-5E illustrate a signal plot of various multipath environments.

FIG. 5F illustrates the Rayleigh fading curve associated with non-impulse radio transmissions in a multipath environment.

FIG. 5G illustrates a plurality of multipaths with a plurality of reflectors from a transmitter to a receiver.

FIG. 5H graphically represents signal strength as volts vs. time in a direct path and multipath environment.

FIG. 6 illustrates a representative impulse radio transmitter functional diagram;

FIG. 7 illustrates a representative impulse radio receiver functional diagram;

FIG. 8A illustrates a representative received pulse signal at the input to the correlator;

FIG. 8B illustrates a sequence of representative impulse signals in the correlation process;

FIG. 8C illustrates the output of the correlator for each of the time offsets of FIG. 8B.

FIG. 9 is a schematic diagram showing a hardware configuration of a typical personal computer (PC) embodying this invention.

FIG. 10 is a schematic diagram showing a hardware configuration of PDA to which data is to be downloaded as a destination station in a preferred embodiment of this invention.

FIG. 11 is a schematic diagram showing a hierarchical configuration of software programs on the PC.

FIG. 12 is a flow chart showing procedures to be followed when PC 900 attempts to download data to the PDA by an impulse radio communication.

FIG. 13 is a schematic diagram showing transactions between the PC and the PDA.

FIG. 14 is a diagram showing an external view of an exemplary personal digital assistant.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in art. Like numbers refer to like elements throughout.

Recent advances in communications technology have enabled an emerging, revolutionary ultra wideband technology (UWB) called impulse radio communications systems (hereinafter called impulse radio). To better understand the benefits of impulse radio to the present invention, the following review of impulse radio follows. Impulse radio was first fully described in a series of patents, including U.S. Pat. No. 4,641,317 (issued Feb. 3, 1987), U.S. Pat. No. 4,813,057 (issued Mar. 14, 1989), U.S. Pat. No. 4,979,186 (issued Dec. 18, 1990) and U.S. Pat. No. 5,363,108 (issued Nov. 8, 1994) to Larry W. Fullerton. A second generation of impulse radio patents includes U.S. Pat. No. 5,677,927 (issued Oct. 14, 1997), U.S. Pat. No. 5,687,169 (issued Nov. 11, 1997) and co-pending application Ser. No. 08/761,602 (filed Dec. 6, 1996) to Fullerton et al.

Uses of impulse radio systems are described in U.S. patent application Ser. No. 09/332,502, entitled, “System and Method for Intrusion Detection using a Time Domain Radar Array” and U.S. patent application Ser. No. 09/332,503, entitled, “Wide Area Time Domain Radar Array” both filed on Jun. 14, 1999 and both of which are assigned to the assignee of the present invention. All of the above patent documents are incorporated herein by reference.

Impulse Radio Basics

Impulse radio refers to a radio system based on short, low duty cycle pulses. An ideal impulse radio waveform is a short Gaussian monocycle. As the name suggests, this waveform attempts to approach one cycle of radio frequency (RF) energy at a desired center frequency. Due to implementation and other spectral limitations, this waveform may be altered significantly in practice for a given application. Most waveforms with enough bandwidth approximate a Gaussian shape to a useful degree.

Impulse radio can use many types of modulation, including AM, time shift (also referred to as pulse position) and M-ary versions. The time shift method has simplicity and power output advantages that make it desirable. In this document, the time shift method is used as an illustrative example.

In impulse radio communications, the pulse-to-pulse interval can be varied on a pulse-by-pulse basis by two components: an information component and a code component. Generally, conventional spread spectrum systems employ codes to spread the normally narrow band information signal over a relatively wide band of frequencies. A conventional spread spectrum receiver correlates these signals to retrieve the original information signal. Unlike conventional spread spectrum systems, in impulse radio communications codes are not needed for energy spreading because the monocycle pulses themselves have an inherently wide bandwidth. Instead, codes are used for channelization, energy smoothing in the frequency domain, resistance to interference, and reducing the interference potential to nearby receivers.

The impulse radio receiver is typically a direct conversion receiver with a cross correlator front end which coherently converts an electromagnetic pulse train of monocycle pulses to a baseband signal in a single stage. The baseband signal is the basic information signal for the impulse radio communications system. It is often found desirable to include a subcarrier with the baseband signal to help reduce the effects of amplifier drift and low frequency noise. The subcarrier that is typically implemented alternately reverses modulation according to a known pattern at a rate faster than the data rate. This same pattern is used to reverse the process and restore the original data pattern just before detection. This method permits alternating current (AC) coupling of stages, or equivalent signal processing to eliminate direct current (DC) drift and errors from the detection process. This method is described in detail in U.S. Pat. No. 5,677,927 to Fullerton et al.

In impulse radio communications utilizing time shift modulation, each data bit typically time position modulates many pulses of the periodic timing signal. This yields a modulated, coded timing signal that comprises a train of pulses for each single data bit. The impulse radio receiver integrates multiple pulses to recover the transmitted information.

Waveforms

Impulse radio refers to a radio system based on short, low duty cycle pulses. In the widest bandwidth embodiment, the resulting waveform approaches one cycle per pulse at the center frequency. In more narrow band embodiments, each pulse consists of a burst of cycles usually with some spectral shaping to control the bandwidth to meet desired properties such as out of band emissions or in-band spectral flatness, or time domain peak power or burst off time attenuation.

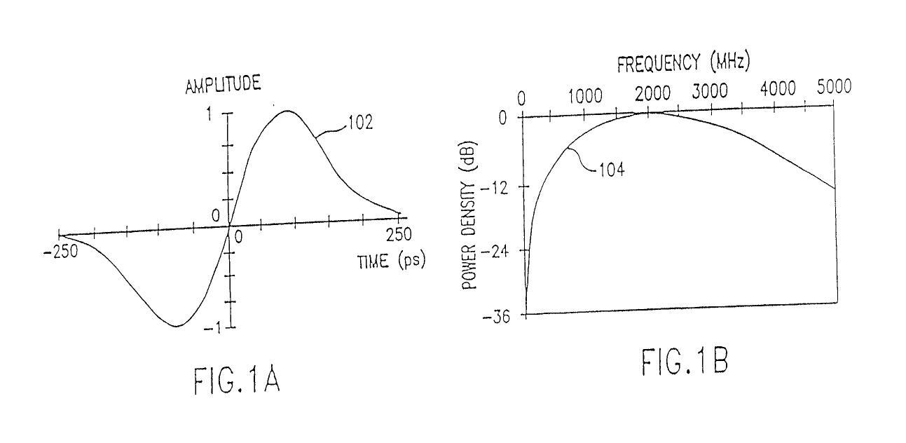

For system analysis purposes, it is convenient to model the desired waveform in an ideal sense to provide insight into the optimum behavior for detail design guidance. One such waveform model that has been useful is the Gaussian monocycle as shown in FIG. 1A. This waveform is representative of the transmitted pulse produced by a step function into an ultra-wideband antenna. The basic equation normalized to a peak value of 1 is as follows:

$${f}_{mono} ( t ) = \sqrt{e} ( \frac{t}{σ} ) {ⅇ}^{\frac{- {t}^{2}}{2 {σ}^{2}}}$$

Where,

σ is a time scaling parameter,

t is time,

fₘₒₙₒ(t) is the waveform voltage, and

e is the natural logarithm base.

The frequency domain spectrum of the above waveform is shown in FIG. 1B. The corresponding equation is:

$${F}_{mono} ( f ) = {( 2 π )}^{\frac{3}{2}} σ f {ⅇ}^{- 2 {( π σ f )}^{2}}$$

The center frequency (f_{c}), or frequency of peak spectral density is:

$${f}_{c} = \frac{1}{2 π σ}$$

These pulses, or bursts of cycles, may be produced by methods described in the patents referenced above or by other methods that are known to one of ordinary skill in the art. Any practical implementation will deviate from the ideal mathematical model by some amount. In fact, this deviation from ideal may be substantial and yet yield a system with acceptable performance. This is especially true for microwave implementations, where precise waveform shaping is difficult to achieve. These mathematical models are provided as an aid to describing ideal operation and are not intended to limit the invention. In fact, any burst of cycles that adequately fills a given bandwidth and has an adequate on-off attenuation ratio for a given application will serve the purpose of this invention.

A Pulse Train

Impulse radio systems can deliver one or more data bits per pulse; however, impulse radio systems more typically use pulse trains, not single pulses, for each data bit. As described in detail in the following example system, the impulse radio transmitter produces and outputs a train of pulses for each bit of information.

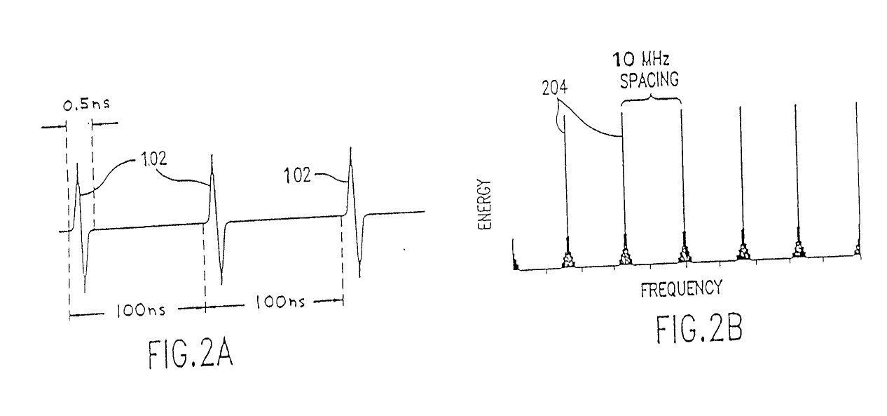

Prototypes have been built which have pulse repetition frequencies including 0.7 and 10 megapulses per second (Mpps, where each megapulse is 10⁶ pulses). FIGS. 2A and 2B are illustrations of the output of a typical 10 Mpps system with uncoded, unmodulated, 0.5 nanosecond (ns) pulses 102. FIG. 2A shows a time domain representation of this sequence of pulses 102. FIG. 2B, which shows 60 MHZ at the center of the spectrum for the waveform of FIG. 2A, illustrates that the result of the pulse train in the frequency domain is to produce a spectrum comprising a set of lines 204 spaced at the frequency of the 10 Mpps pulse repetition rate. When the full spectrum is shown, the envelope of the line spectrum follows the curve of the single pulse spectrum 104 of FIG. 1B. For this simple uncoded case, the power of the pulse train is spread among roughly two hundred comb lines. Each comb line thus has a small fraction of the total power and presents much less of an interference problem to a receiver sharing the band.

It can also be observed from FIG. 2A that impulse radio systems typically have very low average duty cycles resulting in average power significantly lower than peak power. The duty cycle of the signal in the present example is 0.5%, based on a 0.5 ns pulse in a 100 ns interval.

Coding for Energy Smoothing and Channelization

For high pulse rate systems, it may be necessary to more finely spread the spectrum than is achieved by producing comb lines. This may be done by non-uniformly positioning each pulse relative to its nominal position according to a code such as a pseudo random code.

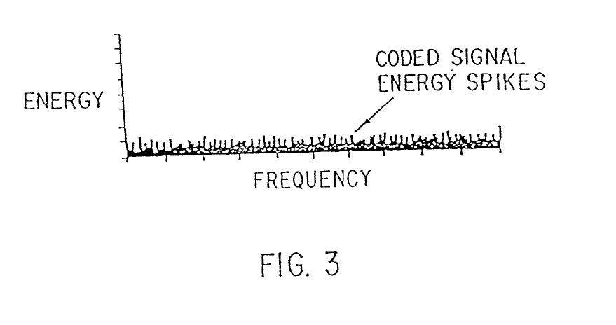

FIG. 3 is a plot illustrating the impact of a pseudo-noise (PN) code dither on energy distribution in the frequency domain (A pseudo-noise, or PN code is a set of time positions defining pseudo-random positioning for each pulse in a sequence of pulses). FIG. 3, when compared to FIG. 2B, shows that the impact of using a PN code is to destroy the comb line structure and spread the energy more uniformly. This structure typically has slight variations that are characteristic of the specific code used.

Coding also provides a method of establishing independent communication channels using impulse radio. Codes can be designed to have low cross correlation such that a pulse train using one code will seldom collide on more than one or two pulse positions with a pulses train using another code during any one data bit time. Since a data bit may comprise hundreds of pulses, this represents a substantial attenuation of the unwanted channel.

Modulation

Any aspect of the waveform can be modulated to convey information. Amplitude modulation, phase modulation, frequency modulation, time shift modulation and M-ary versions of these have been proposed. Both analog and digital forms have been implemented. Of these, digital time shift modulation has been demonstrated to have various advantages and can be easily implemented using a correlation receiver architecture.

Digital time shift modulation can be implemented by shifting the coded time position by an additional amount (that is, in addition to code dither) in response to the information signal. This amount is typically very small relative to the code shift. In a 10 Mpps system with a center frequency of 2 GHz., for example, the code may command pulse position variations over a range of 100 ns; whereas, the information modulation may only deviate the pulse position by 150 ps.

Thus, in a pulse train of n pulses, each pulse is delayed a different amount from its respective time base clock position by an individual code delay amount plus a modulation amount, where n is the number of pulses associated with a given data symbol digital bit.

Modulation further smooths the spectrum, minimizing structure in the resulting spectrum.

Reception and Demodulation

Clearly, if there were a large number of impulse radio users within a confined area, there might be mutual interference. Further, while coding minimizes that interference, as the number of users rises, the probability of an individual pulse from one user's sequence being received simultaneously with a pulse from another user's sequence increases. Impulse radios are able to perform in these environments, in part, because they do not depend on receiving every pulse. The impulse radio receiver performs a correlating, synchronous receiving function (at the RF level) that uses a statistical sampling and combining of many pulses to recover the transmitted information. Impulse radio receivers typically integrate from 1 to 1000 or more pulses to yield the demodulated output. The optimal number of pulses over which the receiver integrates is dependent on a number of variables, including pulse rate, bit rate, interference levels, and range.

Interference Resistance

Besides channelization and energy smoothing, coding also makes impulse radios highly resistant to interference from all radio communications systems, including other impulse radio transmitters. This is critical as any other signals within the band occupied by an impulse signal potentially interfere with the impulse radio. Since there are currently no unallocated bands available for impulse systems, they must share spectrum with other conventional radio systems without being adversely affected. The code helps impulse systems discriminate between the intended impulse transmission and interfering transmissions from others.

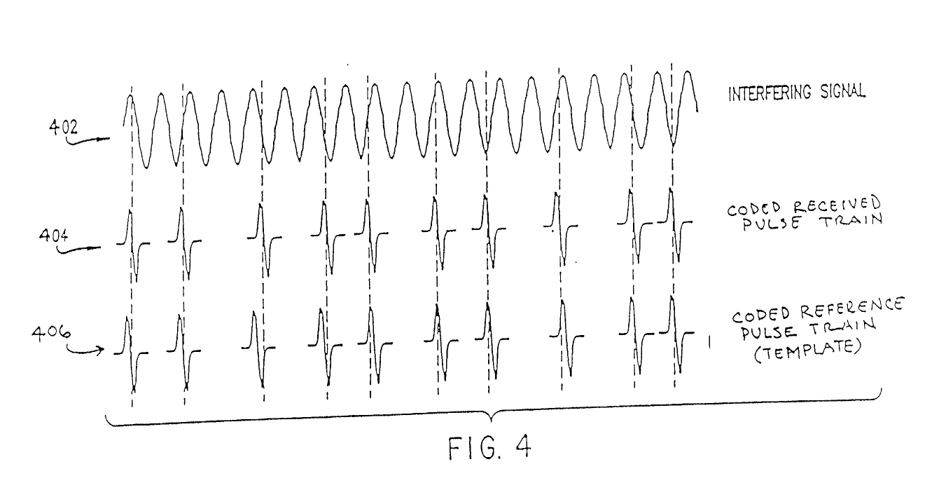

FIG. 4 illustrates the result of a narrow band sinusoidal interference signal 402 overlaying an impulse radio signal 404. At the impulse radio receiver, the input to the cross correlation would include the narrow band signal 402, as well as the received ultrawide-band impulse radio signal 404. The input is sampled by the cross correlator with a code dithered template signal 406. Without coding, the cross correlation would sample the interfering signal 402 with such regularity that the interfering signals could cause significant interference to the impulse radio receiver. However, when the transmitted impulse signal is encoded with the code dither (and the impulse radio receiver template signal 406 is synchronized with that identical code dither) the correlation samples the interfering signals non-uniformly. The samples from the interfering signal add incoherently, increasing roughly according to square root of the number of samples integrated; whereas, the impulse radio samples add coherently, increasing directly according to the number of samples integrated. Thus, integrating over many pulses overcomes the impact of interference.

Processing Gain

Impulse radio is resistant to interference because of its large processing gain. For typical spread spectrum systems, the definition of processing gain, which quantifies the decrease in channel interference when wide-band communications are used, is the ratio of the bandwidth of the channel to the bit rate of the information signal. For example, a direct sequence spread spectrum system with a 10 KHz information bandwidth and a 10 MHz channel bandwidth yields a processing gain of 1000 or 30 dB. However, far greater processing gains are achieved by impulse radio systems, where the same 10 KHz information bandwidth is spread across a much greater 2 GHz channel bandwidth, resulting in a theoretical processing gain of 200,000 or 53 dB.

Capacity

It has been shown theoretically, using signal to noise arguments, that thousands of simultaneous voice channels are available to an impulse radio system as a result of the exceptional processing gain, which is due to the exceptionally wide spreading bandwidth.

For a simplistic user distribution, with N interfering users of equal power equidistant from the receiver, the total interference signal to noise ratio as a result of these other users can be described by the following equation:

$${V}_{tot}^{2} = \frac{N {σ}^{2}}{\sqrt{Z}}$$

Where

V²ₜₒₜ is the total interference signal to noise ratio variance, at the receiver;

N is the number of interfering users;

σ² is the signal to noise ratio variance resulting from one of the interfering signals with a single pulse cross correlation; and

Z is the number of pulses over which the receiver integrates to recover the modulation.

This relationship suggests that link quality degrades gradually as the number of simultaneous users increases. It also shows the advantage of integration gain. The number of users that can be supported at the same interference level increases by the square root of the number of pulses integrated.

Multipath and Propagation

One of the striking advantages of impulse radio is its resistance to multipath fading effects. Conventional narrow band systems are subject to multipath through the Rayleigh fading process, where the signals from many delayed reflections combine at the receiver antenna according to their seemingly random relative phases. This results in possible summation or possible cancellation, depending on the specific propagation to a given location. This situation occurs where the direct path signal is weak relative to the multipath signals, which represents a major portion of the potential coverage of a radio system. In mobile systems, this results in wild signal strength fluctuations as a function of distance traveled, where the changing mix of multipath signals results in signal strength fluctuations for every few feet of travel.

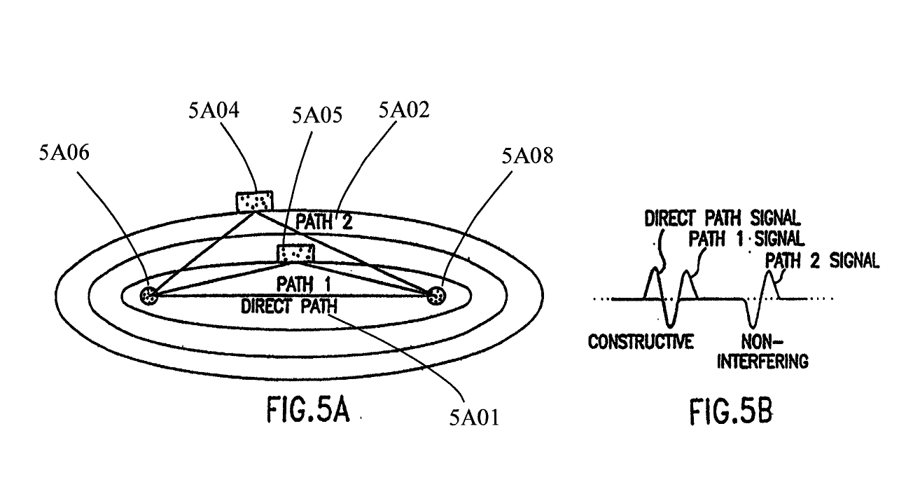

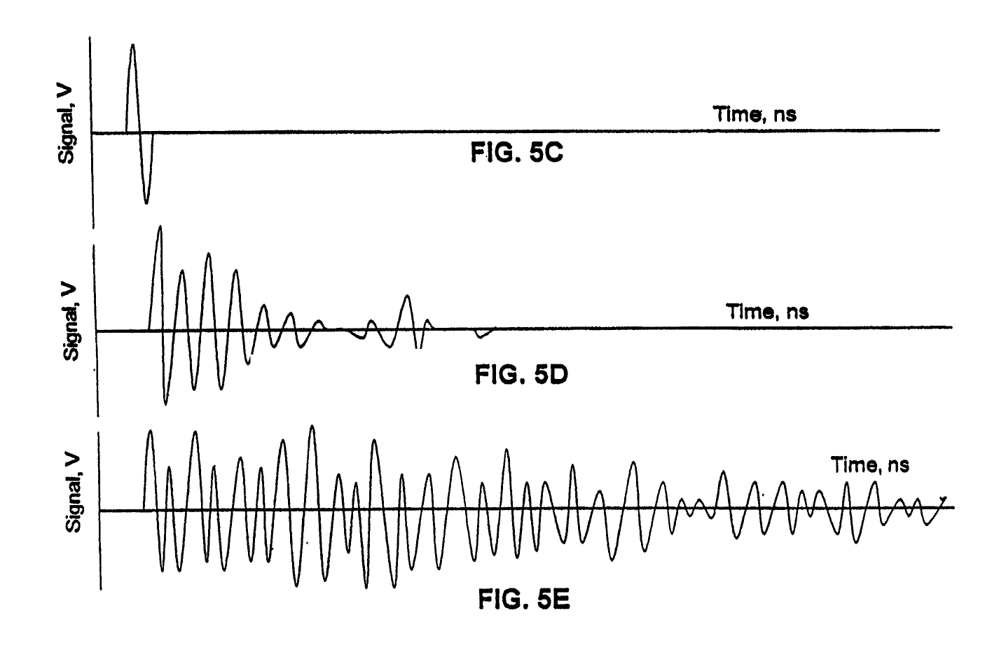

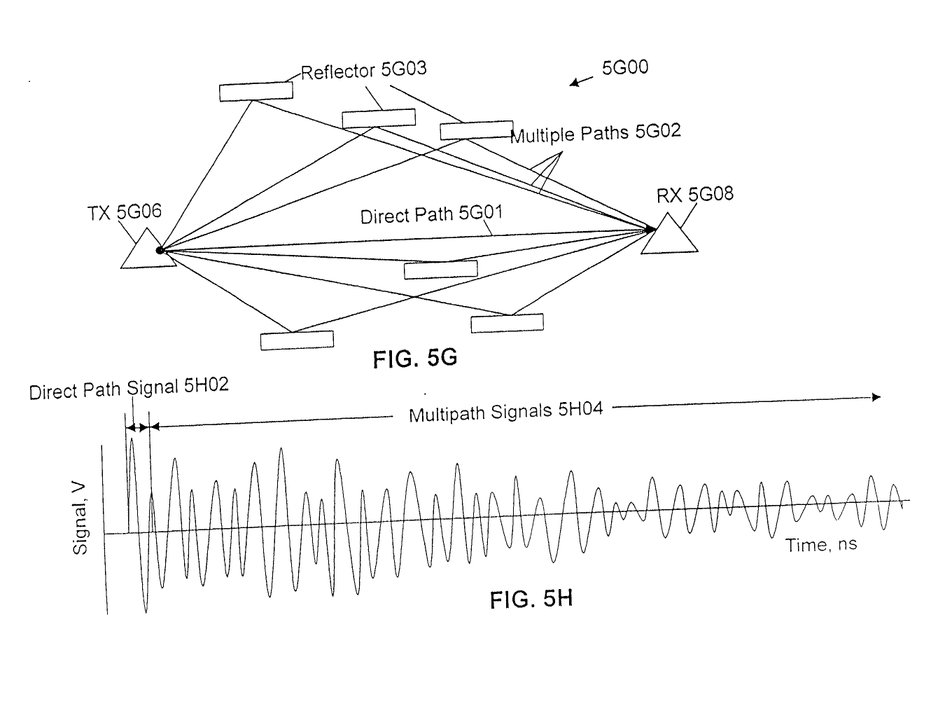

Impulse radios, however, can be substantially resistant to these effects. Impulses arriving from delayed multipath reflections typically arrive outside of the correlation time and thus can be ignored. This process is described in detail with reference to FIGS. 5A and 5B. In FIG. 5A, three propagation paths are shown. The direct path representing the straight-line distance between the transmitter and receiver is the shortest. Path 1 represents a grazing multipath reflection, which is very close to the direct path. Path 2 represents a distant multipath reflection. Also shown are elliptical (or, in space, ellipsoidal) traces that represent other possible locations for reflections with the same time delay.

FIG. 5B represents a time domain plot of the received waveform from this multipath propagation configuration. This figure comprises three doublet pulses as shown in FIG. 1A. The direct path signal is the reference signal and represents the shortest propagation time. The path 1 signal is delayed slightly and actually overlaps and enhances the signal strength at this delay value. Note that the reflected waves are reversed in polarity. The path 2 signal is delayed sufficiently that the waveform is completely separated from the direct path signal. If the correlator template signal is positioned at the direct path signal, the path 2 signal will produce no response. It can be seen that only the multipath signals resulting from very close reflectors have any effect on the reception of the direct path signal. The multipath signals delayed less than one quarter wave (one quarter wave is about 1.5 inches, or 3.5 cm at 2 GHz center frequency) are the only multipath signals that can attenuate the direct path signal. This region is equivalent to the first Fresnel zone familiar to narrow band systems designers. Impulse radio, however, has no further nulls in the higher Fresnel zones. The ability to avoid the highly variable attenuation from multipath gives impulse radio significant performance advantages.

FIG. 5A illustrates a typical multipath situation, such as in a building, where there are many reflectors 5A04, 5A05 and multiple propagation paths 5A02, 5A01. In this figure, a transmitter TX 5A06 transmits a signal that propagates along the multiple propagation paths 5A02, 5A04 to receiver RX 5A08, where the multiple reflected signals are combined at the antenna.

FIG. 5B illustrates a resulting typical received composite pulse waveform resulting from the multiple reflections and multiple propagation paths 5A01, 5A02. In this figure, the direct path signal 5A01 is shown as the first pulse signal received. The multiple reflected signals (“multipath signals”, or “multipath”) comprise the remaining response as illustrated.

FIGS. 5C, 5D, and 5E represent the received signal from a TM-UWB transmitter in three different multipath environments. These figures are not actual signal plots, but are hand drawn plots approximating typical signal plots. FIG. 5C illustrates the received signal in a very low multipath environment. This may occur in a building where the receiver antenna is in the middle of a room and is one meter from the transmitter. This may also represent signals received from some distance, such as 100 meters, in an open field where there are no objects to produce reflections. In this situation, the predominant pulse is the first received pulse and the multipath reflections are too weak to be significant. FIG. 5D illustrates an intermediate multipath environment. This approximates the response from one room to the next in a building. The amplitude of the direct path signal is less than in FIG. 5C and several reflected signals are of significant amplitude. FIG. 5E approximates the response in a severe multipath environment such as: propagation through many rooms; from corner to corner in a building; within a metal cargo hold of a ship; within a metal truck trailer; or within an intermodal shipping container. In this scenario, the main path signal is weaker than in FIG. 5D. In this situation, the direct path signal power is small relative to the total signal power from the reflections.

An impulse radio receiver can receive the signal and demodulate the information using either the direct path signal or any multipath signal peak having sufficient signal to noise ratio. Thus, the impulse radio receiver can select the strongest response from among the many arriving signals. In order for the signals to cancel and produce a null at a given location, dozens of reflections would have to be cancelled simultaneously and precisely while blocking the direct path—a highly unlikely scenario. This time separation of multipath signals together with time resolution and selection by the receiver permit a type of time diversity that virtually eliminates cancellation of the signal. In a multiple correlator rake receiver, performance is further improved by collecting the signal power from multiple signal peaks for additional signal to noise performance.

Where the system of FIG. 5A is a narrow band system and the delays are small relative to the data bit time, the received signal is a sum of a large number of sine waves of random amplitude and phase. In the idealized limit, the resulting envelope amplitude has been shown to follow a Rayleigh probability distribution as follows:

$$p ( r ) = \frac{1}{{σ}^{2}} exp ( \frac{- {r}^{2}}{2 {σ}^{2}} )$$

where

r is the envelope amplitude of the combined multipath signals, and

2σ² is the RMS power of the combined mulitpath signals.

This distribution is shown in FIG. 5F. It can be seen in FIG. 5F that 10% of the time, the signal is more than 16 dB attenuated. This suggests that 16 dB fade margin is needed to provide 90% link availability. Values of fade margin from 10 to 40 dB have been suggested for various narrow band systems, depending on the required reliability. This characteristic has been the subject of much research and can be partially improved by such techniques as antenna and frequency diversity, but these techniques result in additional complexity and cost.

In a high multipath environment such as inside homes, offices, warehouses, automobiles, trailers, shipping containers, or outside in the urban canyon or other situations where the propagation is such that the received signal is primarily scattered energy, impulse radio, according to the present invention, can avoid the Rayleigh fading mechanism that limits performance of narrow band systems. This is illustrated in FIG. 5G and 5H in a transmit and receive system in a high multipath environment 5G00, wherein the transmitter 5G06 transmits to receiver 5G08 with the signals reflecting off reflectors 5G03 which form multipaths 5G02. The direct path is illustrated as 5G01 with the signal graphically illustrated at 5H02, with the vertical axis being the signal strength in volts and horizontal axis representing time in nanoseconds. Multipath signals are graphically illustrated at 5H04.

Distance Measurement

Important for positioning, impulse systems can measure distances to extremely fine resolution because of the absence of ambiguous cycles in the waveform. Narrow band systems, on the other hand, are limited to the modulation envelope and cannot easily distinguish precisely which RF cycle is associated with each data bit because the cycle-to-cycle amplitude differences are so small they are masked by link or system noise. Since the impulse radio waveform has no multi-cycle ambiguity, this allows positive determination of the waveform position to less than a wavelength—potentially, down to the noise floor of the system. This time position measurement can be used to measure propagation delay to determine link distance, and once link distance is known, to transfer a time reference to an equivalently high degree of precision. The inventors of the present invention have built systems that have shown the potential for centimeter distance resolution, which is equivalent to about 30 ps of time transfer resolution. See, for example, commonly owned, co-pending applications Ser. No. 09/045,929, filed Mar. 23, 1998, titled “Ultrawide-Band Position Determination System and Method”, and Ser. No. 09/083,993, filed May 26, 1998, titled “System and Method for Distance Measurement by Inphase and Quadrature Signals in a Radio System,” both of which are incorporated herein by reference.

In addition to the methods articulated above, impulse radio technology along with Time Division Multiple Access algorithms and Time Domain packet radios can achieve geo-positioning capabilities in a radio network. This geo-positioning method allows ranging to occur within a network of radios without the necessity of a full duplex exchange among every pair of radios.

Exemplary Transceiver Implementation

Transmitter

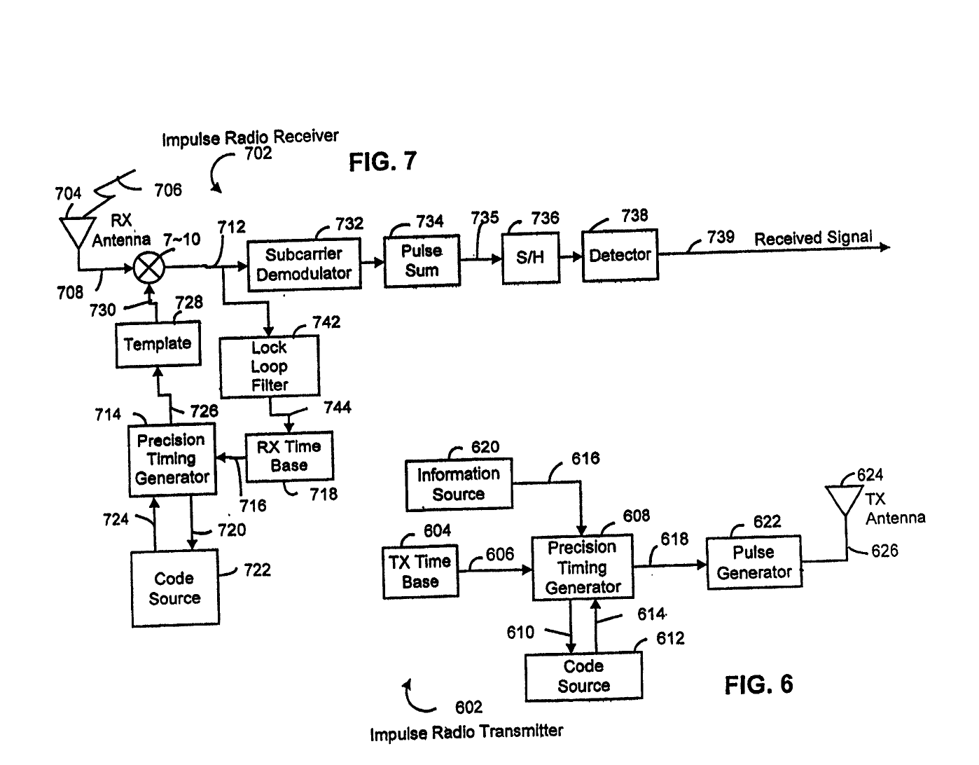

An exemplary embodiment of an impulse radio transmitter 602 of an impulse radio communication system having one subcarrier channel will now be described with reference to FIG. 6.

The transmitter 602 comprises a time base 604 that generates a periodic timing signal 606. The time base 604 typically comprises a voltage controlled oscillator (VCO), or the like, having a high timing accuracy and low jitter, on the order of picoseconds (ps). The voltage control to adjust the VCO center frequency is set at calibration to the desired center frequency used to define the transmitter's nominal pulse repetition rate. The periodic timing signal 606 is supplied to a precision timing generator 608.

The precision timing generator 608 supplies synchronizing signals 610 to the code source 612 and utilizes the code source output 614 together with an internally generated subcarrier signal (which is optional) and an information signal 616 to generate a modulated, coded timing signal 618. The code source 612 comprises a storage device such as a random access memory (RAM), read only memory (ROM), or the like, for storing suitable codes and for outputting the PN codes as a code signal 614. Alternatively, maximum length shift registers or other computational means can be used to generate the codes.

An information source 620 supplies the information signal 616 to the precision timing generator 608. The information signal 616 can be any type of intelligence, including digital bits representing voice, data, imagery, or the like, analog signals, or complex signals.

A pulse generator 622 uses the modulated, coded timing signal 618 as a trigger to generate output pulses. The output pulses are sent to a transmit antenna 624 via a transmission line 626 coupled thereto. The output pulses are converted into propagating electromagnetic pulses by the transmit antenna 624. In the present embodiment, the electromagnetic pulses are called the emitted signal, and propagate to an impulse radio receiver 702, such as shown in FIG. 7, through a propagation medium, such as air, in a radio frequency embodiment. In a preferred embodiment, the emitted signal is wide-band or ultrawide-band, approaching a monocycle pulse as in FIG. 1A. However, the emitted signal can be spectrally modified by filtering of the pulses. This bandpass filtering will cause each monocycle pulse to have more zero crossings (more cycles) in the time domain. In this case, the impulse radio receiver can use a similar waveform as the template signal in the cross correlator for efficient conversion.

Receiver

An exemplary embodiment of an impulse radio receiver (hereinafter called the receiver) for the impulse radio communication system is now described with reference to FIG. 7.

The receiver 702 comprises a receive antenna 704 for receiving a propagated impulse radio signal 706. A received signal 708 is input to a cross correlator or sampler 710 via a receiver transmission line, coupled to the receive antenna 704, and producing a baseband output 712.

The receiver 702 also includes a precision timing generator 714, which receives a periodic timing signal 716 from a receiver time base 718. This time base 718 is adjustable and controllable in time, frequency, or phase, as required by the lock loop in order to lock on the received signal 708. The precision timing generator 714 provides synchronizing signals 720 to the code source 722 and receives a code control signal 724 from the code source 722. The precision timing generator 714 utilizes the periodic timing signal 716 and code control signal 724 to produce a coded timing signal 726. The template generator 728 is triggered by this coded timing signal 726 and produces a train of template signal pulses 730 ideally having waveforms substantially equivalent to each pulse of the received signal 708. The code for receiving a given signal is the same code utilized by the originating transmitter to generate the propagated signal. Thus, the timing of the template pulse train matches the timing of the received signal pulse train, allowing the received signal 708 to be synchronously sampled in the correlator 710. The correlator 710 ideally comprises a multiplier followed by a short term integrator to sum the multiplier product over the pulse interval.

The output of the correlator 710 is coupled to a subcarrier demodulator 732, which demodulates the subcarrier information signal from the subcarrier. The purpose of the optional subcarrier process, when used, is to move the information signal away from DC (zero frequency) to improve immunity to low frequency noise and offsets. The output of the subcarrier demodulator is then filtered or integrated in the pulse summation stage 734. A digital system embodiment is shown in FIG. 7. In this digital system, a sample and hold 736 samples the output 735 of the pulse summation stage 734 synchronously with the completion of the summation of a digital bit or symbol. The output of sample and hold 736 is then compared with a nominal zero (or reference) signal output in a detector stage 738 to determine an output signal 739 representing the digital state of the output voltage of sample and hold 736.

The baseband signal 712 is also input to a lowpass filter 742 (also referred to as lock loop filter 742). A control loop comprising the lowpass filter 742, time base 718, precision timing generator 714, template generator 728, and correlator 710 is used to generate an error signal 744. The error signal 744 provides adjustments to the adjustable time base 718 to time position the periodic timing signal 726 in relation to the position of the received signal 708.

In a transceiver embodiment, substantial economy can be achieved by sharing part or all of several of the functions of the transmitter 602 and receiver 702. Some of these include the time base 718, precision timing generator 714, code source 722, antenna 704, and the like.

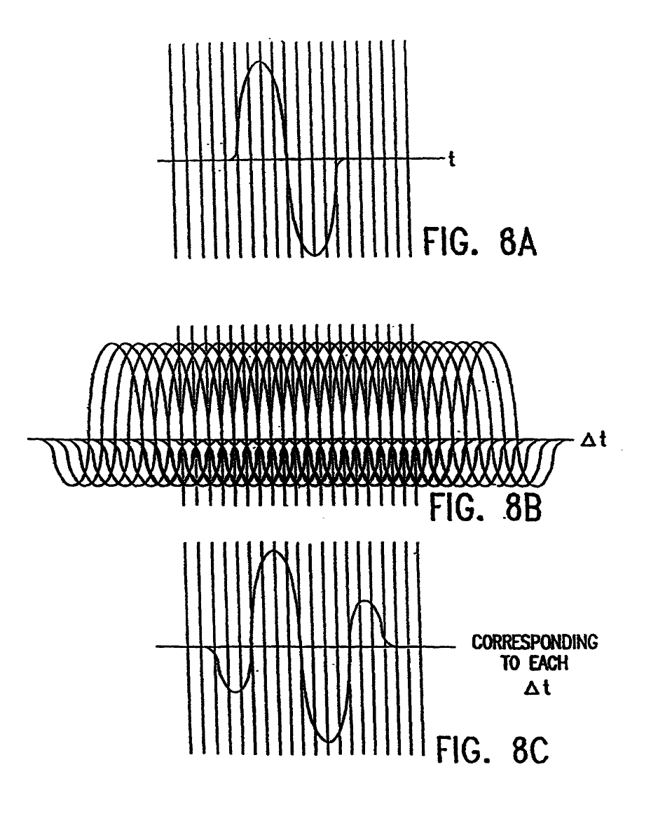

FIGS. 8A-8C illustrate the cross correlation process and the correlation function. FIG. 8A shows the waveform of a template signal. FIG. 8B shows the waveform of a received impulse radio signal at a set of several possible time offsets. FIG. 8C represents the output of the correlator (multiplier and short time integrator) for each of the time offsets of FIG. 8B. Thus, this graph does not show a waveform that is a function of time, but rather a function of time-offset. For any given pulse received, there is only one corresponding point that is applicable on this graph. This is the point corresponding to the time offset of the template signal used to receive that pulse. Further examples and details of precision timing can be found described in U.S. Pat. No. 5,677,927, and commonly owned co-pending application Ser. No. 09/146,524, filed Sep. 3, 1998, titled “Precision Timing Generator System and Method” both of which are incorporated herein by reference.

Recent Advances in Impulse Radio Communication

Modulation Techniques

To improve the placement and modulation of pulses and to find new and improved ways that those pulses transmit information, various modulation techniques have been developed. The modulation techniques articulated above as well as the recent modulation techniques invented and summarized below are incorporated herein by reference.

Flip Modulation

An impulse radio communications system can employ FLIP modulation techniques to transmit and receive flip modulated impulse radio signals. Further, it can transmit and receive flip with shift modulated (also referred to as quadrature flip time modulated (QFTM)) impulse radio signals. Thus, FLIP modulation techniques can be used to create two, four, or more different data states.

Flip modulators include an impulse radio receiver with a time base, a precision timing generator, a template generator, a delay, first and second correlators, a data detector and a time base adjustor. The time base produces a periodic timing signal that is used by the precision timing generator to produce a timing trigger signal. The template generator uses the timing trigger signal to produce a template signal. A delay receives the template signal and outputs a delayed template signal. When an impulse radio signal is received, the first correlator correlates the received impulse radio signal with the template signal to produce a first correlator output signal, and the second correlator correlates the received impulse radio signal with the delayed template signal to produce a second correlator output signal. The data detector produces a data signal based on at least the first correlator output signal. The time base adjustor produces a time base adjustment signal based on at least the second correlator output signal. The time base adjustment signal is used to synchronize the time base with the received impulse radio signal.

For greater elaboration of FLIP modulation techniques, the reader is directed to the patent application entitled, “Apparatus, System and Method for FLIP Modulation in an Impulse Radio Communication System”, Ser. No. 09/537,692, filed Mar. 29, 2000 and assigned to the assignee of the present invention. This patent application is incorporated herein by reference.

Vector Modulation

Vector Modulation is a modulation technique which includes the steps of generating and transmitting a series of time-modulated pulses, each pulse delayed by one of four pre-determined time delay periods and representative of at least two data bits of information, and receiving and demodulating the series of time-modulated pulses to estimate the data bits associated with each pulse. The apparatus includes an impulse radio transmitter and an impulse radio receiver.

The transmitter transmits the series of time-modulated pulses and includes a transmitter time base, a time delay modulator, a code time modulator, an output stage, and a transmitting antenna. The receiver receives and demodulates the series of time-modulated pulses using a receiver time base and two correlators, one correlator designed to operate after a pre-determined delay with respect to the other correlator. Each correlator includes an integrator and a comparator, and may also include an averaging circuit that calculates an average output for each correlator, as well as a track and hold circuit for holding the output of the integrators. The receiver further includes an adjustable time delay circuit that may be used to adjust the pre-determined delay between the correlators in order to improve detection of the series of time-modulated pulses.

For greater elaboration of Vector modulation techniques, the reader is directed to the patent application entitled, “Vector Modulation System and Method for Wideband Impulse Radio Communications”, Ser. No. 09/169,765, filed Dec. 9, 1999 and assigned to the assignee of the present invention. This patent application is incorporated herein by reference.

Receivers

Because of the unique nature of impulse radio receivers several modifications have been recently made to enhance system capabilities.

Multiple Correlator Receivers

Multiple correlator receivers utilize multiple correlators that precisely measure the impulse response of a channel and wherein measurements can extend to the maximum communications range of a system, thus, not only capturing ultra-wideband propagation waveforms, but also information on data symbol statistics. Further, multiple correlators enable rake acquisition of pulses and thus faster acquisition, tracking implementations to maintain lock and enable various modulation schemes. Once a tracking correlator is synchronized and locked to an incoming signal, the scanning correlator can sample the received waveform at precise time delays relative to the tracking point. By successively increasing the time delay while sampling the waveform, a complete, time-calibrated picture of the waveform can be collected.

For greater elaboration of utilizing multiple correlator techniques, the reader is directed to the patent application entitled, “System and Method of using Multiple Correlator Receivers in an Impulse Radio System”, Ser. No. 09/537,264, filed Mar. 29, 2000 and assigned to the assignee of the present invention. This patent application is incorporated herein by reference.

Fast Locking Mechanisms

Methods to improve the speed at which a receiver can acquire and lock onto an incoming impulse radio signal have been developed. In one approach, a receiver comprises an adjustable time base to output a sliding periodic timing signal having an adjustable repetition rate and a decode timing modulator to output a decode signal in response to the periodic timing signal. The impulse radio signal is cross-correlated with the decode signal to output a baseband signal. The receiver integrates T samples of the baseband signal and a threshold detector uses the integration results to detect channel coincidence. A receiver controller stops sliding the time base when channel coincidence is detected. A counter and extra count logic, coupled to the controller, are configured to increment or decrement the address counter by one or more extra counts after each T pulses is reached in order to shift the code modulo for proper phase alignment of the periodic timing signal and the received impulse radio signal. This method is described in detail in U.S. Pat. No. 5,832,035 to Fullerton, incorporated herein by reference.

In another approach, a receiver obtains a template pulse train and a received impulse radio signal. The receiver compares the template pulse train and the received impulse radio signal to obtain a comparison result. The system performs a threshold check on the comparison result. If the comparison result passes the threshold check, the system locks on the received impulse radio signal. The system may also perform a quick check, a synchronization check, and/or a command check of the impulse radio signal. For greater elaboration of this approach, the reader is directed to the patent application entitled, “Method and System for Fast Acquisition of Ultra Wideband Signals”, Ser. No. 09/538,292, filed Mar. 29, 2000 and assigned to the assignee of the present invention. This patent application is incorporated herein by reference.

Baseband Signal Converters

A receiver has been developed which includes a baseband signal converter device and combines multiple converter circuits and an RF amplifier in a single integrated circuit package. Each converter circuit includes an integrator circuit that integrates a portion of each RF pulse during a sampling period triggered by a timing pulse generator. The integrator capacitor is isolated by a pair of Schottky diodes connected to a pair of load resistors. A current equalizer circuit equalizes the current flowing through the load resistors when the integrator is not sampling. Current steering logic transfers load current between the diodes and a constant bias circuit depending on whether a sampling pulse is present.

For greater elaboration of utilizing baseband signal converters, the reader is directed to the patent application entitled, “Baseband Signal Converter for a Wideband Impulse Radio Receiver”, Ser. No. 09/356,384, filed Jul. 16, 1999 and assigned to the assignee of the present invention. This patent application is incorporated herein by reference.

Power Control and Interference

Power Control

Power control improvements have been invented with respect to impulse radios. The power control systems comprise a first transceiver that transmits an impulse radio signal to a second transceiver. A power control update is calculated according to a performance measurement of the signal received at the second transceiver. The transmitter power of either transceiver, depending on the particular embodiment, is adjusted according to the power control update. Various performance measurements are employed according to the current invention to calculate a power control update, including bit error rate, signal-to-noise ratio, and received signal strength, used alone or in combination. Interference is thereby reduced, which is particularly important where multiple impulse radios are operating in close proximity and their transmissions interfere with one another. Reducing the transmitter power of each radio to a level that produces satisfactory reception increases the total number of radios that can operate in an area without saturation. Reducing transmitter power also increases transceiver efficiency.

For greater elaboration of utilizing baseband signal converters, the reader is directed to the patent application entitled, “System and Method for Impulse Radio Power Control”, Ser. No. 09/332,501, filed Jun. 14, 1999 and assigned to the assignee of the present invention. This patent application is incorporated herein by reference.

Mitigating Effects of Interference

To assist in mitigating interference to impulse radio systems a methodology has been invented. The method comprises the steps of: (a) conveying the message in packets; (b) repeating conveyance of selected packets to make up a repeat package; and (c) conveying the repeat package a plurality of times at a repeat period greater than twice the occurrence period of the interference. The communication may convey a message from a proximate transmitter to a distal receiver, and receive a message by a proximate receiver from a distal transmitter. In such a system, the method comprises the steps of: (a) providing interference indications by the distal receiver to the proximate transmitter; (b) using the interference indications to determine predicted noise periods; and (c) operating the proximate transmitter to convey the message according to at least one of the following: (1) avoiding conveying the message during noise periods; (2) conveying the message at a higher power during noise periods; (3) increasing error detection coding in the message during noise periods; (4) re-transmitting the message following noise periods; (5) avoiding conveying the message when interference is greater than a first strength; (6) conveying the message at a higher power when the interference is greater than a second strength; (7) increasing error detection coding in the message when the interference is greater than a third strength; and (8) re-transmitting a portion of the message after interference has subsided to less than a predetermined strength.

For greater elaboration of mitigating interference to impulse radio systems, the reader is directed to the patent application entitled, “Method for Mitigating Effects of Interference in Impulse Radio Communication”, Ser. No. 09/587,033, filed Jun. 02, 1999 and assigned to the assignee of the present invention. This patent application is incorporated herein by reference.

Moderating Interference while Controlling Equipment

Yet another improvement to impulse radio includes moderating interference with impulse radio wireless control of an appliance; the control is affected by a controller remote from the appliance transmitting impulse radio digital control signals to the appliance. The control signals have a transmission power and a data rate. The method comprises the steps of: (a) in no particular order: (1) establishing a maximum acceptable noise value for a parameter relating to interfering signals; (2) establishing a frequency range for measuring the interfering signals; (b) measuring the parameter for the interference signals within the frequency range; and (c) when the parameter exceeds the maximum acceptable noise value, effecting an alteration of transmission of the control signals. For greater elaboration of moderating interference while effecting impulse radio wireless control of equipment, the reader is directed to the patent application entitled, “Method and Apparatus for Moderating Interference While Effecting Impulse Radio Wireless Control of Equipment”, Ser. No. 09/586,163, filed Jun. 2, 1999 and assigned to the assignee of the present invention. This patent application is incorporated herein by reference.

Coding Advances

The improvements made in coding can directly improve the characteristics of impulse radio as used in the present invention. Specialized coding techniques may be employed to establish temporal and/or non-temporal pulse characteristics such that a pulse train will possess desirable properties. Coding methods for specifying temporal and non-temporal pulse characteristics are described in commonly owned, co-pending applications entitled “A Method and Apparatus for Positioning Pulses in Time”, Ser. No. 09/592,249, and “A Method for Specifying Non-Temporal Pulse Characteristics”, Ser. No. 09/592,250, both filed Jun. 12, 2000, and both of which are incorporated herein by reference. Essentially, a temporal or non-temporal pulse characteristic value layout is defined, an approach for mapping a code to the layout is specified, a code is generated using a numerical code generation technique, and the code is mapped to the defined layout per the specified mapping approach.

A temporal or non-temporal pulse characteristic value layout may be fixed or non-fixed and may involve value ranges, discrete values, or a combination of value ranges and discrete values. A value range layout specifies a range of values for a pulse characteristic that is divided into components that are each subdivided into subcomponents, which can be further subdivided, ad infinitum. In contrast, a discrete value layout involves uniformly or non-uniformly distributed discrete pulse characteristic values. A non-fixed layout (also referred to as a delta layout) involves delta values relative to some reference value such as the characteristic value of the preceding pulse. Fixed and non-fixed layouts, and approaches for mapping code element values to them, are described in co-owned, co-pending applications, entitled “Method for Specifying Pulse Characteristics using Codes”, Ser. No. 09/592,290 and “A Method and Apparatus for Mapping Pulses to a Non-Fixed Layout”, Ser. No. 09/591,691, both filed on Jun. 12, 2000 and both of which are incorporated herein by reference.

A fixed or non-fixed characteristic value layout may include one or more non-allowable regions within which a characteristic value of a pulse is not allowed. A method for specifying non-allowable regions to prevent code elements from mapping to non-allowed characteristic values is described in co-owned, co-pending application entitled “A Method for Specifying Non-Allowable Pulse Characteristics”, Ser. No. 09/592,289, filed Jun. 12, 2000 and incorporated herein by reference. A related method that conditionally positions pulses depending on whether or not code elements map to non-allowable regions is described in co-owned, co-pending application, entitled “A Method and Apparatus for Positioning Pulses Using a Layout having Non-Allowable Regions”, Ser. No. 09/592,248 and incorporated herein by reference.

Typically, a code consists of a number of code elements having integer or floating-point values. A code element value may specify a single pulse characteristic (e.g., pulse position in time) or may be subdivided into multiple components, each specifying a different pulse characteristic. For example, a code having seven code elements each subdivided into five components (c0-c4) could specify five different characteristics of seven pulses. A method for subdividing code elements into components is described in commonly owned, co-pending application entitled “Method for Specifying Pulse Characteristics using Codes”, Ser. No. 09/592,290, filed Jun. 12, 2000 previously referenced and again incorporated herein by reference. Essentially, the value of each code element or code element component (if subdivided) maps to a value range or discrete value within the defined characteristic value layout. If a value range layout is used an offset value is typically employed to specify an exact value within the value range mapped to by the code element or code element component.

The signal of a coded pulse train can be generally expressed:

$${s}_{tr}^{( k )} ( t ) = {\sum }_{j} {( - 1 )}^{{f}_{j}^{( k )}} {a}_{j}^{( k )} ω ( {c}_{j}^{( k )} t - {T}_{j}^{( k )} , {b}_{j}^{( k )} )$$

where k is the index of a transmitter, j is the index of a pulse within its pulse train, (−1)fⱼ^{(k)}, aⱼ^{(k)}, cⱼ^{(k)}, and bⱼ^{(k)} are the coded polarity, amplitude, width, and waveform of the jth pulse of the kth transmitter, and Tⱼ^{(k)} is the coded time shift of the jth pulse of the kth transmitter. Note: When a given non-temporal characteristic does not vary (i.e., remains constant for all pulses in the pulse train), the corresponding code element component is removed from the above expression and the non-temporal characteristic value becomes a constant in front of the summation sign.

Various numerical code generation methods can be employed to produce codes having certain correlation and spectral properties. Such codes typically fall into one of two categories: designed codes and pseudorandom codes.

A designed code may be generated using a quadratic congruential, hyperbolic congruential, linear congruential, Costas array or other such numerical code generation technique designed to generate codes guaranteed to have certain correlation properties. Each of these alternative code generation techniques has certain characteristics to be considered in relation to the application of the pulse transmission system employing the code. For example, Costas codes have nearly ideal autocorrelation properties but somewhat less than ideal cross-correlation properties, while linear congruential codes have nearly ideal cross-correlation properties but less than ideal autocorrelation properties. In some cases, design tradeoffs may require that a compromise between two or more code generation techniques be made such that a code is generated using a combination of two or more techniques. An example of such a compromise is an extended quadratic congruential code generation approach that uses two ‘independent’ operators, where the first operator is linear and the second operator is quadratic. Accordingly, one, two, or more code generation techniques or combinations of such techniques can be employed to generate a code without departing from the scope of the invention.

A pseudorandom code may be generated using a computer's random number generator, binary shift-register(s) mapped to binary words, a chaotic code generation scheme, or another well-known technique. Such ‘random-like’ codes are attractive for certain applications since they tend to spread spectral energy over multiple frequencies while having ‘good enough’ correlation properties, whereas designed codes may have superior correlation properties but have spectral properties that may not be as suitable for a given application.

Computer random number generator functions commonly employ the linear congruential generation (LCG) method or the Additive Lagged-Fibonacci Generator (ALFG) method. Alternative methods include inversive congruential generators, explicit-inversive congruential generators, multiple recursive generators, combined LCGs, chaotic code generators, and Optimal Golomb Ruler (OGR) code generators. Any of these or other similar methods can be used to generate a pseudorandom code without departing from the scope of the invention, as will be apparent to those skilled in the relevant art.

Detailed descriptions of code generation and mapping techniques are included in a co-owned patent application entitled “A Method and Apparatus for Positioning Pulses in Time”, Attorney Docket #: 28549-165554, which is hereby incorporated by reference.

It may be necessary to apply predefined criteria to determine whether a generated code, code family, or a subset of a code is acceptable for use with a given UWB application. Criteria to consider may include correlation properties, spectral properties, code length, non-allowable regions, number of code family members, or other pulse characteristics. A method for applying predefined criteria to codes is described in co-owned, co-pending application, entitled “A Method and Apparatus for Specifying Pulse Characteristics using a Code that Satisfies Predefined Criteria”, Ser. No. 09/592,288, filed Jun. 12, 2000 and is incorporated herein by reference.

In some applications, it may be desirable to employ a combination of two or more codes. Codes may be combined sequentially, nested, or sequentially nested, and code combinations may be repeated. Sequential code combinations typically involve transitioning from one code to the next after the occurrence of some event. For example, a code with properties beneficial to signal acquisition might be employed until a signal is acquired, at which time a different code with more ideal channelization properties might be used. Sequential code combinations may also be used to support multicast communications. Nested code combinations may be employed to produce pulse trains having desirable correlation and spectral properties. For example, a designed code may be used to specify value range components within a layout and a nested pseudorandom code may be used to randomly position pulses within the value range components. With this approach, correlation properties of the designed code are maintained since the pulse positions specified by the nested code reside within the value range components specified by the designed code, while the random positioning of the pulses within the components results in desirable spectral properties. A method for applying code combinations is described in co-owned, co-pending application, entitled “A Method and Apparatus for Applying Codes Having Pre-Defined Properties”, Ser. No. 09/591,690, filed Jun. 12, 2000 which is incorporated herein by reference.

### PREFERRED EMBODIMENTS OF THE PRESENT INVENTION

First Embodiment

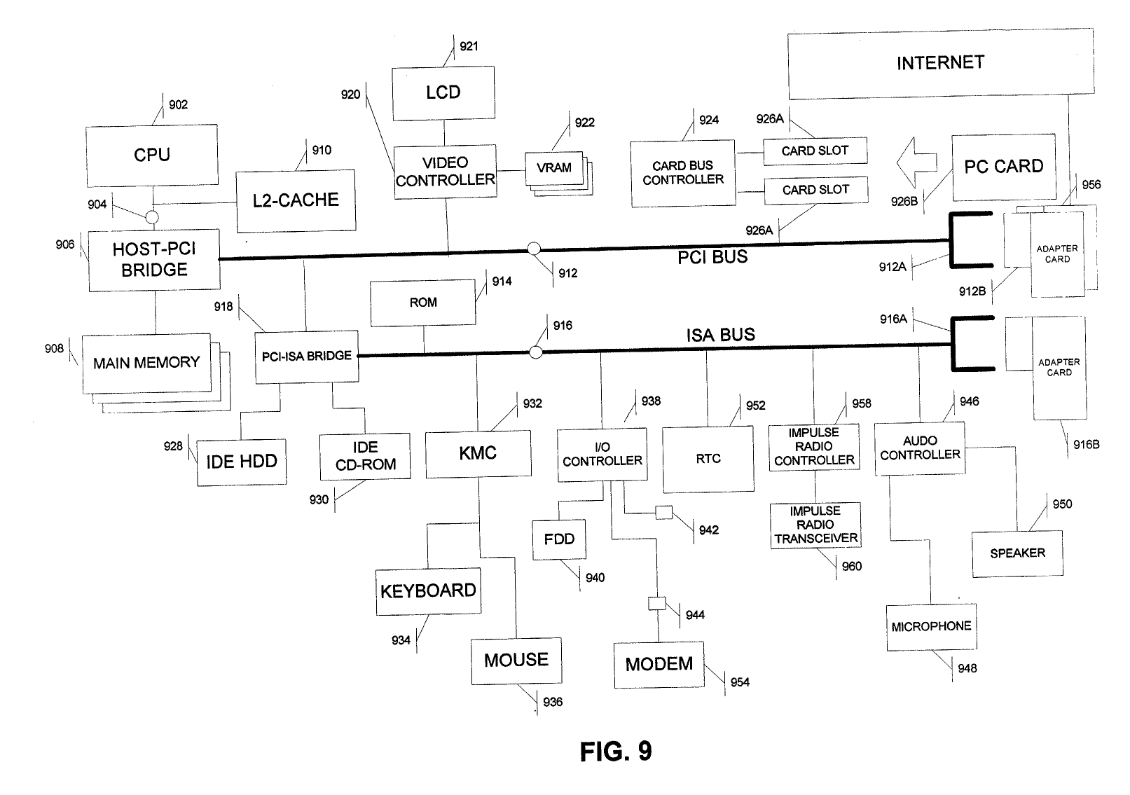

FIG. 9 schematically shows a hardware configuration of a typical personal computer (PC) 900 which embodies this invention. An example for implementing this invention is a type of PC which is pursuant to the specification of OADG (PC Open Architecture Developer's Group). Preferably, PC 900 incorporates an operating system such as “Windows2000” of Microsoft Corp. or “OS/2” of IBM Corp., which provides a multitasking environment. Hereinafter, each component will be described.

CPU 902 acting as a main controller executes a variety of programs under the control of an operating system (OS). CPU 902 may be a CPU chip with a trademark “Pentium” made by Intel Corp.

CPU 902 interconnects with each hardware block (elaborated on hereinafter) through a hierarchical bus structure of three levels, which comprises a processor bus 904 directly coupled to its own external pins, a PCI (Peripheral Component Interconnect) bus 912 as a local bus and an ISA (Industry Standard Architecture) bus 916.

The processor bus 904 and PCI bus 912 are interconnected by a bridge circuit (host-PCI bridge) 906. The bridge circuit 906 of the present embodiment comprises a memory controller for controlling access operations to an main memory 908, a data buffer for absorbing a speed difference between the buses 904 and 912, or the like.

The main memory 908 is a writable memory used as read-in areas or working areas of executed programs. In general, the main memory 908 comprises a plurality of DRAM (dynamic RAM) chips such that its basic capacity is typically 16 MB and extendable up to 128 MB or greater. The executed programs include a variety of software programs such as an OS or “Windows2000”, and an application used for practicing this invention.

L2-cache 910 is a high-speed memory for absorbing access time to the main memory 908 and is used for temporarily storing limited code and data to be frequently accessed by CPU 902. In general, L2-cache 910 comprises SRAM (static RAM) chips and its typical capacity is 256 KB.

PCI bus 912 is a type of bus that enables to transfer data at a relatively high rate (bus width: 32/64 bits, maximum operating frequency: 33/66 MHz, maximum data transfer rate: 132/264 MBps), and is used for connecting relatively fast peripheral devices such as a video controller 920 and a card bus controller 924. As well known in the art, the PCI architecture is based on the proposal of Intel Corp. and implements the PnP (Plug and Play) function.

The video controller 920 is a dedicated controller for actually processing drawing instructions from CPU 902. In operation, it temporarily stores the processed drawing information into a screen buffer (VRAM) 922, reads the drawing information from the VRAM 922 and provides the same as a video output to a liquid crystal display (LCD) 921 or a CRT display. The video controller 920 supports the VGA (Video Graphic Array) function or the SVGA (Super Video Graphic Array) function.

The card bus controller 924 is a dedicated controller for directly coupling those bus signals on PCI bus 912 to a PC card slot 926A. Insertable into the PC card slot 926A is a PC card 926B, which is pursuant to the industry standard (e.g., “PC Card Specification 95”) defined by PCMCIA (Personal Computer Memory Card International Association)/JEIDA (Japan Electronic Industry Development Association). Among a type of the PC card 926B, there is a modem card and a device for implementing connection to a network such as a LAN card. By inserting a PC card of this type, it becomes possible to connect PC 900 to a wide area network such as the Internet.

PCI bus 912 and ISA bus 916 are interconnected by a bridge circuit (PCI-ISA bridge) 918. The bridge circuit 918 of the present embodiment is constructed to contain a DMA controller, a programmable interrupt controller (PIC) and a programmable interval timer (PIT).

Further, the bridge circuit 918 of the present embodiment is provided with an IDE connector, which is pursuant to the IDE (Integrated Drive Electronics), for connecting external storage devices. To this IDE connector, an IDE hard disk drive (HDD) 928 and an IDE CD-ROM drive 930 can be connected. Relatedly, accessing to a file on a hard disk or a CD-ROM is executed by an OS subsystem called “File Manager”. HDD 928 is better than another external storage device in terms of access rate. Accordingly, by copying software programs (OS, device drivers, applications or the like) onto disks of HDD 928 (i.e., “installing” them into the system), these programs are ready for use by the system. Further, CD-ROM drive 930 is primarily used for installing software programs stored in a CD-ROM into the system.

ISA bus 916 has a slower data transfer rate than PCI bus 912 (bus width: 16 bits, maximum data transfer rate: 4 Mbps) and, thus, it is used for connecting relatively slower peripheral devices such as a ROM 914, a keyboard/mouse controller (KMC) 932, an I/O controller 938, an audio controller 946, a real time clock (RTC) 952 or the like.

ROM 914 is a non-volatile memory, which permanently stores code groups (BIOS: Basic Input/Output System) for controlling respective hardware components such as the video controller 920, a keyboard 934, a floppy disk drive (FDD) 940 or the like, in addition to a POST (Power On Self Test) program or the like.

The keyboard/mouse controller (KMC) 932 is a dedicated controller for capturing input scan codes from the keyboard 934 or input coordinate values from a mouse 936 as computer data.

I/O controller 938 is a peripheral controller for controlling drive operations of the floppy disk drive (FDD) 940, as well as data I/O operations of an external device connected via a parallel port 942 or a serial port 944. To the parallel port 942, a printer (not shown) or the like is connected. To the serial port 944, a modem 954 is connected. The modem is a device for transmitting computer data in a digital form via an analog telephone line and, more particularly, it is constructed to modulate transmission data and to demodulate received data. With provision of the modem 954, it becomes possible to connect PC 900 to a wide area network such as the Internet.

Similarly to HDD 928 and CD-ROM 930, FDD 940 is one of the external storage devices. FDD 940 is primarily used for installing software programs provided in the form of a CD-ROM into the system, or for storing working data/files onto a FD.

The audio controller 946 is a dedicated controller for performing I/O processing of audio signals and, more particularly, it is constructed to capture audio signals from a microphone 948 into the system, or to convert audio data into an analog form for outputting from a speaker 950.

The real time clock (RTC) 952 is a device for measuring the current time-of-day. In general, RTC 952 is mounted on a single chip with a CMOS memory (not shown). Typically, this CMOS memory is used for temporarily storing critical information to the system 900 such as system configuration information and a power on password. RTC/CMOS 952 is backed up by a back up battery (normally a coin battery: not shown) so that the measured/stored contents are not lost even after PC 900 goes to its power-off state.

Impulse radio controller 958 is a dedicated controller for implementing impulse radio communication with an external device (PDA 1000 in the present embodiment and described hereafter) in accordance with the aforementioned impulse radio communication techniques. Impulse radio transceiver 960 is a module for actually performing transmission/reception of impulse radio communications in accordance with the methodologies described above in the impulse radio basics section of this application and in the patents and patent applications incorporated herein by reference. As illustrated, the impulse radio controller 958 can be connected to the ISA bus 916. In the alternative, the impulse radio controller 958 can be connected to the computer 900 in the form of a PC Card 926B or an adapter card 912A and 912B or the like.

At one end of each bus 912/926, at least one bus slot 912A/916A is provided respectively. To the bus slots 912A and 916A, a PCI compatible adapter card 912B and an ISA compatible adapter card 916B may be mounted respectively. On each adapter card 912B/916B, hardware may be manipulated by using device drivers dedicated to each card. One example of the adapter cards is a network card for implementing connection to LAN (Ethernet or Token Ring). Inserting such a card into a bus slot, it is possible to connect the personal system 900 to a world area network such as the Internet.

A typical user of the personal computer 900 operates the system through keyboard 934 or mouse 936 to execute various application programs such as a word processing program, a spreadsheet program, a communication program or the like so that the executed result is useful for accomplishing his/her work on the display screen (i.e., desktop). A user may install a desired application into the system by copying the same from CD-ROM drive 930 or FDD 940 onto HDD 928. Alternatively, a desired application may be installed into the system by downloading the same from a Web server to HDD 928. It is noted that this invention may be implemented in the form of an application program so installed.

Personal computers commercially available in the current marketplace will sufficiently function as the computer system 900 shown in FIG. 9. While additional electronic circuits or the like other than those shown in FIG. 9 are required to construct the computer system 900, these components are not described in the present specification, since they are well known in the art. Further, it should be understood that for clarity of the drawings, only a portion of the connections between the illustrated hardware blocks is shown.

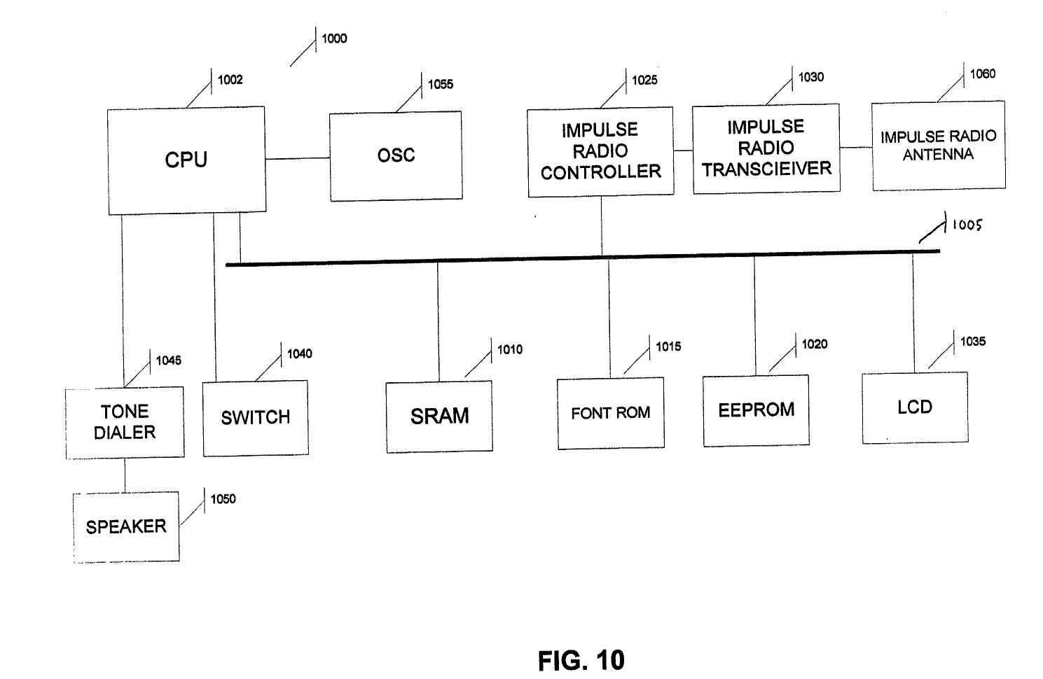

FIG. 10 schematically shows a hardware configuration of PDA 1000, which is to receive download data as its destination in the present embodiment.

CPU 1002 acting as a main controller operates under the control of operating clocks supplied from a clock oscillator (OSC) 1055. CPU 1002 may be a 16 bit micro processor called “TLCS-9001” made by Toshiba Corp. External pins of CPU 1002 are coupled to an internal bus 1005 so that it is interconnected to respective components via the internal bus 1005.

SRAM 1010 is a writable memory that does not require a refresh operation and it is primarily used as a working area of CPU 1002. Font ROM 1015 is a read only memory for storing each character image (i.e., font) displayable on a liquid crystal display (LCD) panel 1035. EEPROM 1020 is a read only memory that is erasable under certain conditions and it is primarily used for permanently storing control codes for operating respective hardware component and security data such as a serial number. CPU 1002 of the present embodiment drives the display 1035 by using a font image in the Font ROM 1015.

Impulse radio controller 1025 is a dedicated controller for processing impulse radio communications transmitted/received by impulse radio transceiver 1030 and impulse radio antenna 1060 and for capturing the same as computer data. A switch 1040 is one of the input devices provided on a housing surface of PDA 1000. PDA 1000 is designed such that it enters into an impulse radio reception (i.e., data download) mode by applying a predetermined action (e.g., depression) to the switch 1040.

Further, CPU 1002 causes a tone dialer 1045 to generate sounds of predetermined frequencies from a speaker 1050.

Additional electronic circuits or the like other than those shown in FIG. 10 may be required to construct PDA 1000; however, these components are not described in the present specification, since they are well known in the art. Further, it should be understood that for clarity of the drawings, only a portion of the connections between the illustrated hardware blocks are shown.

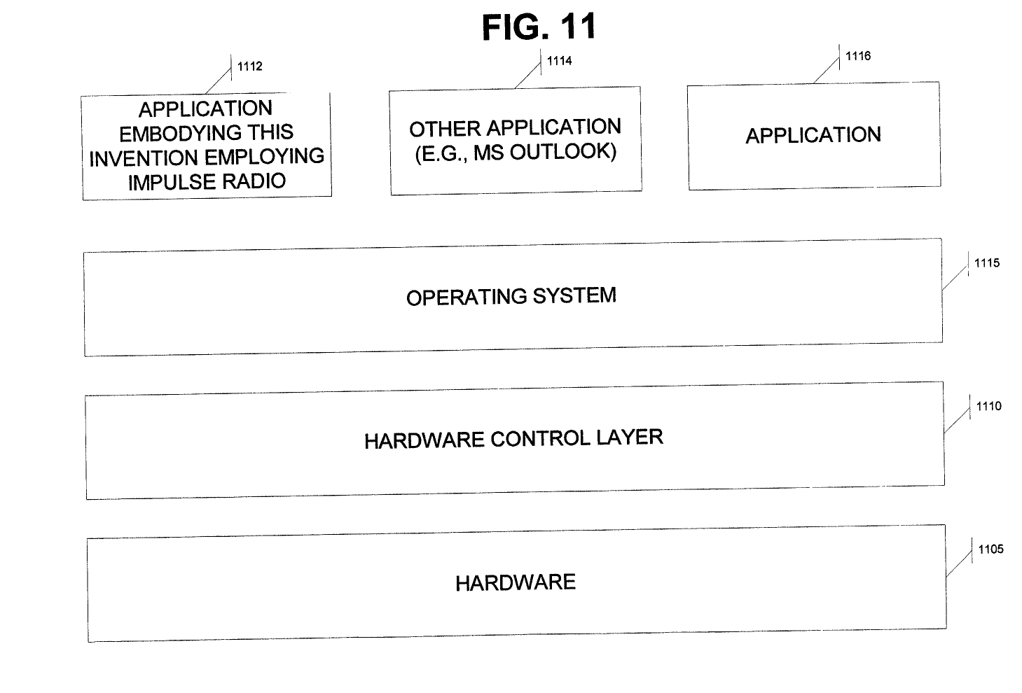

FIG. 11 schematically shows a hierarchical configuration of software programs that are executable on the personal computer 900.

The hardware control layer 1110 located at the lowest level is a software layer for causing any physical difference of respective hardware 1105 (due to different makers or versions) to be invisible to software at a higher level (such as an operating system, applications or the like). For example, a module containing the hardware control layer 1110 converts a command of generic form issued by software at a higher level into an inherent form adapted for driving hardware. The hardware control layer 1110 may be provided on a motherboard as a standard feature in the form of BIOS (Basic Input/Output System) stored in ROM 914. Alternatively, the hardware control layer 1110 may be installed into the system in the form of device drivers (e.g., a mouse driver, a printer driver, a CD-ROM driver or the like).

Operating system 1115 (OS) is basic software for controlling hardware/software of the system as a whole, which includes said “OS/2”, “Windows2000”, “UNIX” or the like. In order to implement this invention in a preferred manner, the operating system is preferably provided with a multitasking function. In general, the operating system comprises a kernel region and a user region.

The kernel region contains a collection of respective basic functions for monitoring overall operations of PC 900 to support execution of various programs such as applications. In a core portion of the kernel region, there is contained “File Manager” for managing recordation of a file onto an auxiliary storage device such as HDD 928, “Scheduler” for managing an order of task execution and priorities, “Memory Manager” for assigning memory areas, “Resource Manager” for managing system resources such as I/O addresses and DMA levels, or the like.

On the other hand, the user region comprises functional routine portions for supporting applications selected by a user and, more particularly, it contains “User Interface” and “Window System”. “User Interface” (alternatively called ‘shell’) has functions for interpreting a command from the user, for conveying the same to the core portion of the kernel region and for conveying a response from the core portion to the user. “Window System” is a functional portion for executing window display on the display 921, which includes “X Window” of UNIX, ‘Presentation Manager’ of OS/2 or the like. Further, within the user region, there is contained a library (called ‘shared library’ or ‘dynamic link library (DLL)) that comprises a collection of functions or data to be shared by plural software programs. As a user interface widely used today, there is “GUI (Graphical User Interface)” that is designed to display in a bitmap form and to support click/drag-and-drop function of an icon by a mouse.

Application programs on the top layer 1112, 1114 and 1116 are the ones used for practical purposes, which includes a word processing program, a database program, a spreadsheet program, a communication program or the like. The application 1112 for embodying this invention, which employs and controls impulse radio for data transfer and synchronization, is also provided on the top layer.

Normally, a user may obtain his/her required software program (OS, device drivers, applications or the like) in the form of a storage medium such as a FD, a CD-ROM or the like. By mounting such a storage medium into its associated drive unit and by copying a desired software program into a disk in HDD 928 (i.e., “installing” into the system), the system becomes ready for using the same (as described above). Further, as another approach that has gained popularity recently, a desired application may be installed into the system by downloading the same from an external computer system (e.g., a Web server) connected to a network.

In the preceding sections, we have described hardware/software configurations of the computer system 900 and PDA 1000 implementing this invention. Now, in the present section, we will describe the processing procedures of the software required to provide impulse radio communications between the computer system 900 and PDA 1000.

The impulse radio communication software may be installed into the computer system 900 by mounting a storage medium for storing this application program in a tangible form such as a CD or a FD into a storage device such as CD-ROM drive 930 or FDD 940 and by copying into a hard disk, for example. Alternatively, this application program may be installed into the system 900 or temporarily loaded into the memory 908 by downloading the same from another computer system (e.g., a Web server) through a network (e.g., the Internet).

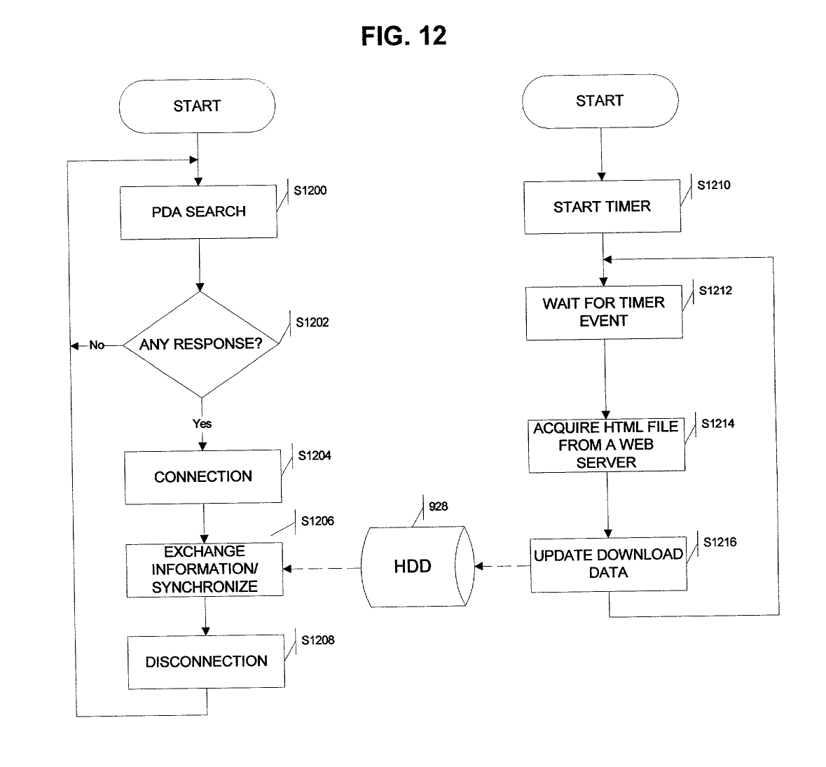

FIG. 12 shows a flow chart of the procedure processed by PC 900 when it attempts to download data to PDA 1000 by impulse radio communications. An impulse radio icon can be utilized to active the impulse radio communications software. This software is presented by an operating system such as “Windows2000”, “OS/2” or the like on the desktop screen of PC 900. A user can start the impulse radio communication software by double clicking this icon (i.e., a double-click operation of the mouse 936).

Impulse radio communication software comprises a download data acquisition phase (corresponding with steps S1210 through S1216 shown in FIG. 12) and a data download phase (corresponding with steps S1200 through S1208 shown in FIG. 12). These phases are executed in a substantially simultaneous or concurrent manner in a multitasking environment.

In the data acquisition phase, a timer having a predetermined timeout value (e.g., 10 minutes) is set at first (step S1210). Whenever the timeout value expires, a timer event occurs (step S1212).

In response to occurrence of this timer event, a pre-registered HTML (HyperText Markup Language) file is acquired from a predetermined Web server on the Internet (step S1214). Normally, connection to the Internet is done in accordance with the TCP/IP protocol (as well known in the art). Further, an HTML file may be normally designated by a URL (Uniform Resource Locator) character string. Moreover, accessing to a Web server is done in accordance with a protocol described by URL (e.g., “http (HyperText Transfer Protocol)”), as well known in the art. Incidentally, acquisition of a selected HTML file only is done in accordance with a general observation that a user of a PDA (i.e., in a mobile environment) prefers to have selected information only (e.g., a Web page such as a newspaper article, stock quotations, a weather report, traffic information or the like).

A newly acquired HTML file replaces a file having the same name and being already stored in HDD 928, thereby to save it as download data. As a result, within the hard disk of PC 900, the most recent HTML file is always cached. The acquired HTML file may be converted into a form adapted for downloading, or into another form adapted for processing by a destination of download data. For example, an image portion of an HTML file may be removed to leave a text portion only, or an HTML file may be truncated into a predetermined file size based on a predetermined rule.

On the other hand, in the data download phase, PC 900 starts transmission of an “XID (exchange ID) command” frame from an impulse radio transceiver 960 to conduct “Station Search”, namely, to search for PDA 1000 as a destination of the download data (step S1200). PC 900 continues the station search operation (step S1202) unless there is an explicit indication of suspension of the impulse radio communication. XID methodologies can be employed by one of ordinary skill in the impulse radio art by using the coding techniques described above and in the patents and patent applications which are all incorporated herein by reference.

When PDA 1000 is in the impulse radio communication mode and its impulse radio transceiver 1030 comes within a predetermined range of impulse radio transceiver 960 of PC 900 (distance and position determination is described in detail above and in the patents and patent applications herein incorporated by reference), PDA 1000 issues an “XID response” frame in response to the XID command (described above), thereby to effectuate the station search. Within each frame of the XID command and the XID response, respective device drivers are included, whereby each party can acknowledge the other party's address respectively. In addition to the XID command, impulse radio techniques allow for unique channelization and authentication schemes and coding methodologies for identification. For example, each impulse radio can transmit on a given channel (channels in the impulse radio environment are described in detail above) and communications will only occur if the impulse radio receiver is “listening” with the proper correlation codes.

Next, setup of a connection between PC 900 and PDA 1000 is carried out (step S1204). This setup of connection means a negotiation procedure for determining a communication rate of frames, a data size or the like between PC 900 and PDA 1000. Included in this setup can be integration requirements given the distance and multipath environment. For example, if the distance is small and the data rate is large a small number of pulses can be integrated to represent one data bit. However, if limited data rates are required, then a larger number of pulses can be integrated to represent one data bit and can therefore communicate in a “noisy” environment better. For setup of connection, PC 900 transmits an SNRM (Set Normal Response Mode). In response, PDA 1000 returns either a UA (Unnumbered Acknowledgement) frame or a DM (Disconnected Mode) frame depending on whether or not the description content of the SNRM frame is acceptable to it.

When PC 900 receives the UA frame and establishes the connection, it eventually enters into a state where information can be exchanged via impulse radio IR communications (step S1206). PC 900 serially transmits download data stored in its own HDD 928 in the form of I (information) frames.

Download data to PDA 1000 is an HTML file acquired in advance from a Web server. As described above, PC 900 periodically acquires a pre-registered HTML file from a predetermined Web server and stores the same into HDD 928 (steps S1214, S1216). Namely, PC 900 periodically updates download data to be used by PDA 1000 and, thus, it may function as a cache of PDA. On the other hand, to PDA 1000 entered into a receipt mode, download data is immediately transferred by simply placing it within the predetermined range of impulse radio transceiver 960. PDA 1000 may not be required to support complex functions such as the TCP/IP protocol to acquire desired data such as a Web page or the like. Further, since PDA 1000 does not have to be connected to a network (e.g., the Internet) on its own initiative, it does not require the execution of complex processing procedures associated with establishment of a connection and accessing to a server, nor is it subject to battery consumption associated with such accessing time. Moreover, since impulse radio communication has the potential of data transfer rates in the range of tens of Mbps (Basic Rate ISDN: 64 kbps), it takes only several seconds to receive desired data (e.g., an HTML file). As mentioned above, depending on data rates desired, the number of pulses used for integration can be varied thus adapting to the needs of the system.

Upon completion of a data transfer, disconnecting the connection is carried out (step S1208). At this time, PC 900 transmits a DISC (Disconnection) frame, whereas PDA responds to this by returning a UA frame.

After the connection is disconnected, PC 900 initializes the communication state, and PDA 1000 resets the communication mode. However, PC 900 returns to the station search mode (step S1200) and, unless the transmission state is explicitly reset by the user, it continually issues an XID command to retry the station search. Thus, when a user simply holds PDA 1000 (or another PDA) that is set into the communication mode to PC 900 again, data download operations similar to those described above will be developed. Even during the station search, download data (e.g., an HTML file) is sequentially updated and, thus, PDA 1000 is able to acquire the most recent data smoothly and instantaneously.

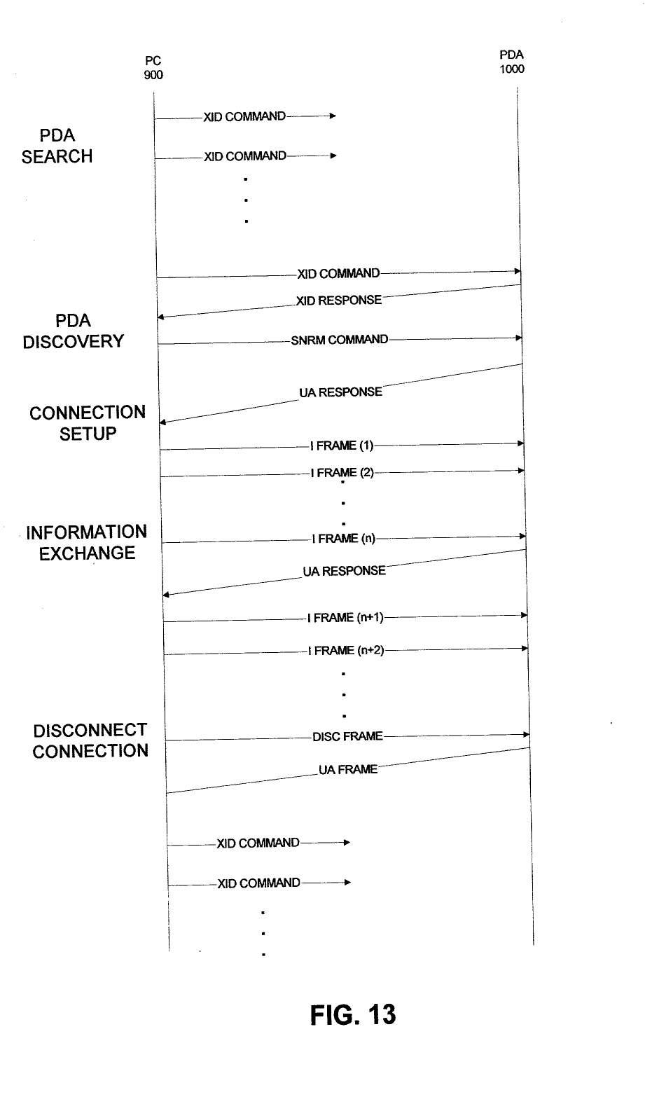

FIG. 13 schematically shows transactions between PC 900 and PDA 1000 in an impulse radio transfer.

Firstly, PC 900 continually transmits XID commands to search for a secondary station (PDA 1000). PDA 1000, which comes within the predetermined range of an impulse radio transceiver 960 of PC 900, is responsive to an XID command to issue an XID response. As a result, PC 900 searches out PDA 1000 as a secondary station.

Next, PC 900 transmits an SNRM frame for carrying setup content of a connection (e.g., a communication rate of a frame, a data size, integration criteria or the like). If the content of this SNRM frame is acceptable to PDA 1000, it issues a UA response and implements the setup of this connection. Otherwise, PDA 1000 issues a DM response and, as a result of this, the same connection setup procedure is repeated.

Once a connection between PC 900 and PDA 1000 is established, both enter into a state where information can be exchanged. In the present embodiment, information transmission is substantially carried out in a unidirectional way from PC 900 to PDA 1000. Namely, PC 900 transfers an I frame containing download data by an impulse radio communication. In this case, PDA 1000 returns a response to PC 900 whenever the timer times out, thereby to acknowledge receipt of the I frame between PC 900 and PDA 1000. If PDA 1000 has its own information to be transmitted, it returns an I frame as a response; otherwise, it issues a RR (Receive Ready) or RNR (Receive Not Ready) response.

Upon termination of download of predetermined data, PC 900 transmits a DISC frame to request disconnection. In this case, PDA 1000 returns a UA response, thereby to establish disconnection.

After the connection is disconnected, PC 900 initializes the communication state, whereas PDA 1000 terminates the communication state. However, PC 900 starts transmission of an XID command again to search for a station (PDA 1000). This station search is continued unless the transmission state is explicitly reset by the user. Thus, when a user simply holds PDA 1000 (or another PDA) that is set into the communication mode to PC 900 again, data download operations similar to those described above will be developed.

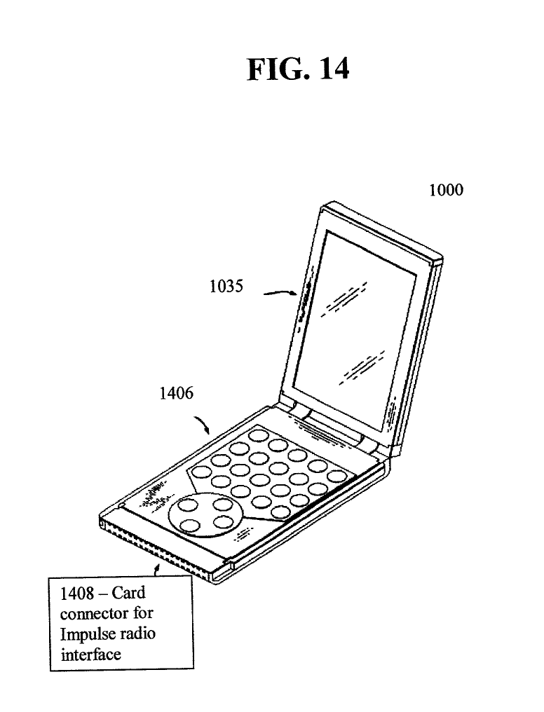

FIG. 14 illustrates an example of a possible configuration of a PDA 1000. As shown, PDA 1000, can include a card connector 1408 for interface with an impulse radio transceiver if one is not built into the PDA 1000 itself. Keyboard 1406 provides for data input into and control of PDA 1000. And display 1402 enables viewing of the processed data in the form desired.

While the present embodiment has been described on the basis of the so-called PC/AT compatible machines conforming to the OADG specification, it is apparent that this invention may be implemented in other machines as well (e.g., PC 98 series of NEC Corp., Macintosh of Apple Computer, Inc. and compatible machines thereof).

Further, while the present embodiment has been described by taking the case of acquisition of Web data by a PDA, this invention may apply to other data that may be acquired through a network (e.g., Lotus Notes, a file at an FTP (File Transfer Protocol) site, Gopher, NewsReader or the like).

As described above in detail, in accordance with this invention, it is possible to provide an improved information processing apparatus and a method for controlling the same, which enables the smooth transfer of data, such as processed results obtained from execution of an application program, an HTML file acquired from a Web server in accordance with the TCP/IP protocol or the like, to an external device (PDA) by using impulse radio communications. This can all be done without imposing burdens on the external device.

While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements which embody the spirit and scope of the present invention.

What is claimed is:

1. A communications device having an impulse radio communication function, comprising:
impulse radio means for transmitting/receiving impulse radio communications;
file acquisition means for acquiring a file from an information processing apparatus,
input means for allowing a user to input user commands; and
means, responsive to a data download command from the user, for entering and staying in a station search state to transmit an impulse radio code to search for the information processing apparatus from which data is to be downloaded.

2. The communications device having an impulse radio communication function of claim 1, further comprising a memory for storing said acquired file.

3. The communications device having an impulse radio communication function of claim 1, wherein said data download begins automatically when said communications device is within a predetermined range, as determined by impulse radio means, of said information processing apparatus.

4. The communications device having an impulse radio communication function of claim 1, wherein said information processing apparatus includes a connection means for connecting to a network and wherein data of said data download is updated from a server located within said network.

5. The communications device having an impulse radio communication function of claim 1, further comprising means, responsive to receipt of an impulse radio code from said information processing apparatus that indicates a response of station discovery from said information processing apparatus, for executing an impulse radio communication to receive the download data from said information processing apparatus; and
means, responsive to termination of said impulse radio communication with said information processing apparatus for returning to the station search state.

6. An information processing apparatus having an impulse radio communication function, comprising:
an impulse radio transceiver for transmitting and receiving impulse radio communications;
means for entering a station search state to transmit an impulse radio code to search for a personal digital assistant to which data is to be downloaded;
means, responsive to receipt of an impulse radio code that indicates a response of discovery of said personal digital assistant, for executing an impulse radio communication to transmit the download data to the personal digital assistant; and
means, responsive to termination of the impulse radio communication with the personal digital assistant, for returning to the station search state.

7. The information processing apparatus having an impulse radio communication function of claim 6, wherein said data download begins automatically when said personal digital assistant is within a predetermined range, as determined by impulse radio means, of said information processing apparatus.

8. The information processing apparatus having an impulse radio communication function of claim 6, further comprising a connection means for connecting to a network.

9. The information processing apparatus having an impulse radio communication function of claim 8, further comprising a file acquisition means, for acquiring a file from a predetermined server through said network, said file acquisition means attempting to assure that the file is the most updated version available from the predetermined server.

10. The information processing apparatus having an impulse radio communication function of claim 9, further comprising a memory for storing the acquired file as download data to be downloaded to said personal digital assistant.

11. A method of controlling a communications device having an impulse radio means for transmitting or receiving impulse radio signals, a memory for storing download data, and an input means for allowing a user to input user commands, comprising the steps of:
responsive to a data download command from the user, entering and staying in a communications device search state to transmit an impulse radio code to search for an information processing apparatus from which data is to be downloaded; and
responsive to receipt of an impulse radio code that indicates a response from said information processing apparatus, executing impulse radio communications to transmit the download data from said information processing apparatus to said communications device.

12. The method according the claim 11, further comprising automatically beginning a data download, data upload or data synchronization between said personal digital assistant and said information processing apparatus when said personal digital assistant is with a predetermined range of said information processing apparatus as determined by impulse radio distance determining techniques.

13. The method according to claim 11, further comprising the step of responsive to termination of said impulse radio communication with the information processing apparatus, returning to the station search state.

14. The method according to claim 11, further comprising the step of connecting said information processing apparatus to a network.

15. The method according to claim 14, further comprising the step of acquiring a file from a predetermined server through said network, the file acquisition operation attempting to assure that the file is the most updated version available from the predetermined server.

16. The method according to claim 14, wherein said network is the Internet.

17. A method of controlling an information processing apparatus having an impulse radio transceiver for transmitting or receiving impulse radio signals, a memory for storing download data, and an input means for allowing a user to input user commands, comprising the steps of:
entering and staying in a station search state to transmit an impulse radio code to search for a personal digital assistant for which data is to be downloaded to, downloaded from or synchronized with; and
responsive to receipt of an impulse radio code that indicates a response from said personal digital assistant, executing impulse radio communications to transmit the download data to said personal digital assistant, upload data from the personal digital assistant or synchronize data with said personal digital assistant.

18. The method according to claim 17, further comprising the step of responsive to termination of said impulse radio communication with the personal digital assistant, returning to the station search state.

19. The method according to claim 17, further comprising the step of connecting said information processing apparatus to a network.

20. The method according to claim 19, further comprising the step of acquiring a file from a predetermined server through said network, the file acquisition operation attempting to assure that the file is the most updated version available from the predetermined server.

21. The method according the claim 17, further comprising upon a receipt of an impulse radio code that indicates a response from said personal digital assistant, determining by impulse radio means the distance between said information processing apparatus and said personal digital assistant.

22. The method according the claim 21, further comprising automatically beginning a data download, upload or synchronization between said personal digital assistant and said information processing apparatus when said personal digital assistant is with a predetermined range of said information processing apparatus as determined by impulse radio distance determining techniques.

23. An information processing apparatus having an impulse radio communication function of the type which transmits an exchange ID (XID) command to search for a personal digital assistant, establishes a connection with said personal digital assistant in response to receipt of an XID response from the personal digital assistant indicating station discovery, and disconnects the connection in response to transmission of a disconnection (DISC) frame by itself and receipt of an unnumbered acknowledgement (UA) frame from the destination station, comprising:
impulse radio means for attempting to disconnect the connection by transmitting a DISC frame; and
said impulse radio means, responsive to disconnection of the connection, for returning to a station search state.

24. A method of controlling an information processing apparatus having an impulse radio communication function of the type which transmits an exchange ID (XID) command to search for a destination station, establishes a connection with said destination station in response to receipt of an XID response from the destination station indicating station discovery, and disconnects the connection in response to transmission of a disconnection (DISC) frame by said information processing apparatus and receipt of an unnumbered acknowledgement (UA) frame from the destination station, comprising the steps of:
attempting to disconnect the connection by transmitting a DISC frame by impulse radio means; and
responsive to disconnection of the connection, returning to a station search state.

25. A computer readable storage medium for storing in a tangible form a computer program executable on a computer system, comprising an impulse radio transceiver for transmitting/receiving an impulse radio code, a memory for storing download data, input means for allowing a user to input user commands, said computer program comprising:
a routine, responsive to a data download command from the user, for entering and staying in a station search state to begin an impulse radio transmission to search for a personal digital assistant to which data is to be downloaded; and
a routine, responsive to receipt of an impulse radio code that indicates a response of station discovery from the personal digital assistant, for executing an impulse radio communication to transmit the download data.

26. The computer readable storage medium for storing in a tangible form a computer program executable on a computer system of claim 25, further comprising a routine, responsive to termination of the impulse radio communication with the destination station, for returning to the station search state.

27. The computer readable storage medium for storing in a tangible form a computer program executable on a computer system of claim 25, further comprising:
a routine for acquiring a file from a predetermined server through a network, the file acquisition routine attempting to assure that the file is the most updated version available from a predetermined server; and
a routine for storing the acquired data as the download data.

28. A computer readable storage medium for storing in a tangible form a computer program executable on a computer system comprising, an impulse radio transceiver for transmitting/receiving an impulse radio code, a memory for storing download data, input means for allowing a user to input user commands, said computer program comprising:
a routine, for acquiring a file from a predetermined server through a network, the file acquisition routine attempting to assure that the file is the most updated version available from the predetermined server; and
a routine for storing the acquired data as the download data;
a routine, responsive to a data download command from the user, for entering and staying in a station search state to transmit an impulse radio code to search for a destination station to which data is to be downloaded;
a routine, responsive to receipt of an impulse radio code that indicates a response of station discovery from the destination station, for executing an impulse radio communication to transmit the download data; and
a routine, responsive to termination of the impulse radio communication with the destination station, for returning to the station search state.

29. A computer readable storage medium for storing in a tangible form a computer program executable on a computer system having an impulse radio communication function of the type which transmits by itself an exchange ID (XID) command, by impulse radio means, to search for a destination station, establishes a connection with the destination station in response to receipt of an XID response, received by impulse radio means, from the destination station indicating station discovery, and disconnects the connection in response to transmission of a disconnection (DISC) frame by itself and receipt of an unnumbered acknowledgement (UA) frame from the destination station, said computer program comprising:
a routine for attempting to disconnect the connection by transmitting a DISC frame by impulse radio means; and
a routine, responsive to disconnection of the connection, for returning to an impulse radio station search state.

30. An information processing apparatus having an impulse radio wireless communication function, comprising:
an impulse radio transceiver for transmitting/receiving an impulse radio wireless code;
connection means for connecting to a network;
file acquisition means, being operative without the involvement of said impulse radio wireless transceiver, for acquiring a file from a predetermined server through said network, wherein the file acquisition means attempts to assure that the file is the most updated version available from the predetermined server;
a memory for storing the acquired file as download data;
input means for allowing a user to input user commands; and
means, responsive to a data download command from the user, for entering and staying in an impulse radio station search state to transmit an impulse radio wireless code to search for a personal digital assistant to which the download data is to be transmitted.
